(19) United States
(12) Patent Application Publication
(10) Pub. No.: US 2014/0368440 A1
(43) Pub. Date: Dec. 18, 2014

(54) ELECTROACTIVE POLYMER ACTUATOR HAPTIC GRIP ASSEMBLY

(71) Applicants: Ilya Polyakov, San Francisco, CA (US); Alireza Zarrabi, Sunnyvale, CA (US); Roger N Hitchcock, San Leandro, CA (US); Xina Quan, Saratoga, CA (US); Chris A Weaber, Montara, CA (US)

(72) Inventors: Ilya Polyakov, San Francisco, CA (US); Alireza Zarrabi, Sunnyvale, CA (US); Roger N Hitchcock, San Leandro, CA (US); Xina Quan, Saratoga, CA (US); Chris A Weaber, Montara, CA (US)

(73) Assignee: BAYER INTELLECTUAL PROPERTY GMBH, 40789 Monheim (DE)

(21) Appl. No.: 13/576,240

(22) PCT Filed: Feb. 3, 2011
(86) PCT No.: PCT/US11/00196

§ 371 Date: Sep. 8, 2014

Related U.S. Application Data
(60) Provisional application No. 61/301,177, filed on Feb. 3, 2010.

(51) Int. Cl. G06F 3/01; G06F 1/16

(52) U.S. Cl. CPC G06F 3/016; G06F 1/1626
USPC 345/173

(57) ABSTRACT

The present invention provides a housing to allow for removable coupling of electroactive polymer transducer with an electronic media device, where the housing produces an improved haptic effect in the electronic media device.

### RELATED APPLICATION

The present application claims priority to U.S. Provisional Application No. 61/301,177 filed Feb. 3, 2010 entitled “Haptic Grip Case”, the entirety of which is incorporated herein by reference.

### FIELD OF THE INVENTION

The present invention is directed to the use of electroactive polymer transducers to provide an improved haptic response.

### BACKGROUND

A tremendous variety of devices used today rely on actuators of one sort or another to convert electrical energy to mechanical energy. Conversely, many power generation applications operate by converting mechanical action into electrical energy. Employed to harvest mechanical energy in this fashion, the same type of device may be referred to as a generator. Likewise, when the structure is employed to convert physical stimulus such as vibration or pressure into an electrical signal for measurement purposes, it may be characterized as a sensor. Yet, the term “transducer” may be used to generically refer to any of the devices.

A number of design considerations favor the selection and use of advanced dielectric elastomer materials, also referred to as “electroactive polymers” (EAPs), for the fabrication of transducers. These considerations include potential force, power density, power conversion/consumption, size, weight, cost, response time, duty cycle, service requirements, environmental impact, etc. As such, in many applications, EAP technology offers an ideal replacement for piezoelectric, shape-memory alloy (SMA) and electromagnetic devices such as motors and solenoids.

Examples of EAP devices and their applications are described in U.S. Pat. Nos. 7,394,282; 7,378,783; 7,368,862; 7,362,032; 7,320,457; 7,259,503; 7,233,097; 7,224,106; 7,211,937; 7,199,501; 7,166,953; 7,064,472; 7,062,055; 7,052,594; 7,049,732; 7,034,432; 6,940,221; 6,911,764; 6,891,317; 6,882,086; 6,876,135; 6,812,624; 6,809,462; 6,806,621; 6,781,284; 6,768,246; 6,707,236; 6,664,718; 6,628,040; 6,586,859; 6,583,533; 6,545,384; 6,543,110; 6,376,971 and 6,343,129; and in U.S. Published Patent Application Nos. 2009/0001855; 2009/0154053; 2008/0180875; 2008/0157631; 2008/0116764; 2008/0022517; 2007/0230222; 2007/0200468; 2007/0200467; 2007/0200466; 2007/0200457; 2007/0200454; 2007/0200453; 2007/0170822; 2006/0238079; 2006/0208610; 2006/0208609; and 2005/0157893, and U.S. patent application Ser. No. 12/358,142 filed on Jan. 22, 2009; PCT application No. PCT/US09/63307; and WO 2009/067708, the entireties of which arc incorporated herein by reference.

An EAP transducer comprises two electrodes having deformable characteristics and separated by a thin elastomeric dielectric material. When a voltage difference is applied to the electrodes, the oppositely charged electrodes attract each other thereby compressing the polymer dielectric layer therebetween. As the electrodes are pulled closer together, the dielectric polymer film becomes thinner (the z-axis component contracts) as it expands in the planar directions (along the x- and y-axes), i.e., the displacement of the film is in-plane. The EAP film may also be configured to produce movement in a direction orthogonal to the film structure (along the z-axis), i.e., the displacement of the film is out-of-plane. U.S. Published Patent Application No. 2005/0157893 discloses EAP film constructs which provide such out-of-plane displacement—also referred to as surface deformation or as thickness mode deflection.

The material and physical properties of the EAP film may be varied and controlled to customize the deformation undergone by the transducer. More specifically, factors such as the relative elasticity between the polymer film and the electrode material, the relative thickness between the polymer film and electrode material and/or the varying thickness of the polymer film and/or electrode material, the physical pattern of the polymer film and/or electrode material (to provide localized active and inactive areas), the tension or pre-strain placed on the EAP film as a whole, and the amount of voltage applied to or capacitance induced upon the film may be controlled and varied to customize the features of the film when in an active mode.

Numerous transducer-based applications exist which would benefit from the advantages provided by such EAP films. One such application includes the use of EAP films to produce haptic feedback (the communication of information to a user through forces applied to the user's body) in user interface devices. There are many known user interface devices that employ haptic feedback, typically in response to a force initiated by the user. Examples of user interface devices that may employ haptic feedback include keyboards, keypads, game controller, remote control, touch screens, computer mice, trackballs, stylus sticks, joysticks, etc. The user interface surface can comprise any surface that a user manipulates, engages, and/or observes regarding feedback or information from the device. Examples of such interface surfaces include, but are not limited to, a key (e.g., keys on a keyboard), a game pad or buttons, a display screen, etc.

The haptic feedback provided by these types of interface devices is in the form of physical sensations, such as vibrations, pulses, spring forces, etc., which a user senses either directly (e.g., via touching of the screen), indirectly (e.g., via a vibrational effect such a when a cell phone vibrates in a purse or hag) or otherwise sensed (e.g., via an action of a moving body that creates a pressure disturbance but does not generate an audio signal in the traditional sense).

Moreover, the proliferation of electronic media devices such as smart phones, personal media players, portable computing devices, portable gaming systems, electronic readers, etc., can create a situation where a sub-segment of customers would benefit or desire an improved haptic effect in the electronic media device. However, increasing haptic capabilities in every model of an electronic media device may not be justified due to increased cost or increased profile of the device. Moreover, customers of certain electronic media devices may desire to temporarily improve the haptic capabilities of the electronic media device for certain activities.

Haptic feedback capabilities are known to improve user productivity and efficiency, particularly in the context of data entry. The present inventors believe that further improvements to the character and quality of the haptic sensation communicated to a user may further increase such productivity and efficiency. It would be additionally beneficial if such improvements were provided by a sensory feedback mechanism which is easy and cost-effective to manufacture, and does not add to, and preferably reduces, the space, size and/or mass requirements of known haptic feedback devices.

While the incorporation of EAP based transducers can improve the haptic interaction on such user interface devices, there remains a need to temporarily employ such EAP transducers without increasing the profile of the actual electronic media device. Furthermore, there also remains a need to either temporarily or permanently improve the haptic capability of a fully functional stand alone electronic media device so that the user can decide whether or not to improve haptic capabilities of the stand alone electronic media device.

### SUMMARY OF THE INVENTION

The present invention includes devices, systems and methods involving electroactive polymer transducers for haptic or sensory applications. In one variation, the device includes a housing assembly capable of being removable coupled with an electronic media device. The electronic media device can deliver an output signal to an output port, where the housing assembly produces a haptic effect in response to the output signal of the electronic media device. Alternate variations of the devices and methods disclosed herein can use transducers or actuators in place of or in combination with electroactive polymers. Such transducers or actuators can comprise piezoelectric transducers, vibratory motors, etc.

One benefit of the devices and method described herein includes the ability to retrofit or customize an electronic media device to provide the user with improved haptic feedback whenever an input is triggered by software or another signal generated by the device or associated components.

The electroactive polymer artificial muscle (“EPAM”) transducers that can be used with these designs include, but are not limited to Planar, Diaphragm, Thickness Mode, and Passive Coupled devices (Hybrids) as well as any type of EPAM device described in the commonly assigned patents and applications cited herein.

One variation of a housing assembly for removably coupling with an electronic media device comprises a housing case adapted to nest at least a portion of electronic media device, the housing including at least one media device connector adapted to detachably couple to the output port of the electronic media device; at least one electroactive polymer actuator having an active portion configured to produce movement in response to a triggering signal; a body mass located within the housing case and coupled to the electroactive polymer actuator, where haptic effect of the electroactive polymer actuator comprises an inertial movement of the body mass; and at least one drive electronics assembly configured to electronically couple the electroactive polymer actuator to the media device connector, such that the drive electronics assembly is capable of generating the triggering signal in response to the output signal of the electronic media device. Variations of such devices can include any type of transducer including non-electroactive polymer transducers.

In many cases, the electronic media device comprises a stand-alone device that remains operable upon detaching from the housing assembly. However, variations include using a media device that is not operable unless coupled to the housing assembly. Additional variations of the housing assemblies include assemblies that do not have a separate battery or power supply. Instead, the electroactive polymer actuator can be powered by an external source or by the media device. In some variations, the electroactive polymer actuator comprises at least one electroactive polymer cartridge, where the electroactive polymer cartridge includes an electroactive polymer film comprising a dielectric elastomer layer, wherein a portion of the dielectric elastomer layer is between a first and a second electrodes wherein the overlapping portions of the electrodes define an active area comprising the active portion, whereupon application of a triggering signal to the electrodes causes movement of the active area to produce the haptic effect.

The electroactive polymer actuator can include a plurality of discrete electroactive polymer cartridges coupled together, where the electroactive polymer actuator includes an increased active portion comprising each active area of each electroactive polymer cartridge.

In some variations, a body mass can be located within the housing case and coupled to the electroactive polymer actuator, where the haptic effect of the electroactive polymer actuator comprises an inertial movement of the body mass that is driven by the electroactive polymer actuator. While the body mass could be a separate inertial mass it could also comprise a battery, an electronics circuit board or other functional component. In alternate variations, the electroactive actuator is coupled to the media device, such that the haptic effect is discernable on the media device.

In some cases, the housing comprises a pocket located within an interior of the housing case, where the body mass is located within the pocket. The pocket can be sized to limit movement of the body mass to limit movement of the electroactive polymer actuator. By limiting movement of the electroactive polymer actuator, the pocket reduces the chance that the electroactive polymer will be damaged through over-extension.

The power supply can be used as the inertial mass and can be coupled to the electroactive polymer actuator such that movement of the active area causes inertial movement of the power supply to produce the haptic effect.

The housing assembly can optionally include at least one audio speaker, where the electronic drive assembly is configured to pass the output signal of the electronic media device through to the audio speaker.

The housing assembly can comprise any number of parts. In those cases where the assembly case comprises more than one piece, the pieces can be configured to be removably coupled together to nest the electronic media assembly.

The invention also includes a method of augmenting an electronic media device to produce an improved haptic effect. In one variation, the method includes providing a housing including at least one media device connector adapted to couple to an output port of the electronic media device, the housing further includes at least one electroactive polymer actuator having an active portion; coupling the output port of the electronic media device to device connector; producing a triggering signal in response to an output signal of the electronic media device; and generating the improved haptic effect by transmitting the triggering signal to the electroactive polymer actuator to cause movement of the active portion.

In certain variations, the method includes generating the improved haptic effect by transmitting the triggering signal to the electroactive polymer actuator to cause movement of the active portion causes inertial movement of a body mass within the housing case. Optionally, the body mass can comprise a portion of the housing assembly such as the power supply or other components.

In another variation, the method includes powering the electroactive polymer actuator using the power supply, which is electrically isolated from the electronic media device.

Another variation of the method includes producing the triggering signal in response to the output signal of the electronic media device by transmitting the output signal to at least one external speaker coupled to the housing case.

The methods described herein can include assessing the output signal and selecting an output mode of the electroactive actuator from a plurality of output modes depending on the output signal.

The invention described herein further includes a method of producing a housing assembly to augment a haptic effect of an electronic media device when coupled thereto. For example, the method can include positioning at least one electroactive polymer actuator having an active portion within a housing structure including at least one media device connector that allows for detachable joining of the electronic media device to the housing structure; coupling an inertial mass to the active portion, such that movement of the active portion creates the haptic effect by inertial movement of the inertial mass, where the haptic effect is felt in the housing assembly or electronic media device when coupled thereto; and providing within the housing electronic drive circuitry to electrically couple the media device connector to the electroactive polymer actuator and to generate a trigger signal upon receipt of an output signal from the electronic media device, where the electronic drive circuitry is configured to transmit the trigger signal to the electroactive polymer actuator to cause movement of the active portion.

The method of producing a housing assembly to augment a haptic effect of an electronic media device when coupled thereto can further include increasing a total surface area of the active portion by coupling a plurality of electroactive polymer cartridges, each having an electroactive polymer film comprising a dielectric elastomer layer, wherein a portion of the dielectric elastomer layer is between a first and a second electrodes wherein the overlapping portions of the electrodes define an active area; where the active portion comprises a total area of the plurality of active areas.

In another variation, the method can include configuring the electronic drive circuitry to assess the output signal and select an output mode of the electroactive actuator from a plurality of output modes depending on the output signal.

As for other details of the present invention, materials and alternate related configurations may he employed as within the level of those with skill in the relevant art. The same may hold true with respect to method-based aspects of the invention in terms of additional acts as commonly or logically employed. In addition, though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Any number of the individual parts or subassemblies shown may be integrated in their design. Such changes or others may be undertaken or guided by the principles of design for assembly.

These and other features, objects and advantages of the invention will become apparent to those persons skilled in the art upon reading the details of the invention as more fully described below. In addition, variations of the methods and devices described herein include combinations of the embodiments or of aspects of the embodiments where possible are within the scope of this disclosure even if those combinations are not explicitly shown or discussed.

### BRIEF DESCRIPTION OF THE DRAWINGS

The invention is best understood from the following detailed description when read in conjunction with the accompanying drawings. To facilitate understanding, the same reference numerals have been used (where practical) to designate similar elements that are common to the drawings. Included in the drawings are the following:

FIGS. 1A and 1B illustrate a top perspective view of a transducer before and after application of a voltage in accordance with one embodiment of the present invention;

FIG. 2A illustrates an exemplary electroactive polymer cartridge;

FIG. 2B illustrates an exploded view of an electroactive polymer actuator, inertial mass and actuator housing;

FIG. 2C illustrates a partial cross sectional view of an actuator component housing;

FIG. 2D, illustrates a planar view of an actuator spacer;

FIGS. 2E and 2F illustrate a bottom view and side view of an inertial mass with spacers;

FIGS. 3A to 3C illustrate another variation of a two phase transducer;

FIG. 3D illustrates a graph of displacement versus time for the two phase transducer of FIGS. 3A to 3C;

FIGS. 4A and 4B graphically illustrate the force-stroke relationship and voltage response curves, respectively, of an actuator of when operated in a single-phase mode;

FIGS. 4C and 4D graphically illustrate the force-stroke relationship and voltage response curves, respectively, of the actuator of FIGS. 3A-3C when operated in a two-phase mode;

FIG. 5 is a block diagram of electronic circuitry, including a power supply and control electronics, for operating the sensory feedback device;

FIGS. 6A to 6C illustrates one example of a housing assembly for removably coupling to an electronic media device;

FIG. 6D shows a representation of a view as taken along the line 6D-6D in FIG. 6C;

FIGS. 7A to 7C show another variation of a gaming housing assembly for removably coupling to an electronic media device;

FIG. 7D shows a sectional view taken along the lines 7C-7C in FIG. 7A;

FIG. 8A shows another variation of a housing assembly;

FIG. 8B shows a partial cut away section of the assembly of FIG. 8A;

FIG. 9A illustrates one example of a circuit to tune an audio signal to work within optimal haptic frequencies for electroactive polymer actuators;

FIG. 9B illustrates an example of a modified haptic signal filtered by the circuit of FIG. 9A;

FIGS. 9C and 9D illustrate additional circuits for producing signals for single and double phase electroactive transducers;

FIG. 10 illustrates an example of a circuit to drive an electroactive polymer transducer using a triggering signal (such as an audio signal) to deliver a stored waveform for producing a desired haptic effect;

FIGS. 11A and 11B illustrate another variation for driving an electroactive polymer transducer by providing two-phase activation with a single drive circuit;

FIG. 12A illustrates one variation of a flow chart used to determine the actuator mode based on the input signal;

FIG. 12B illustrates on possible example of a trigger circuit;

FIG. 12C provides an example of the control architecture used for a variation of the electroactive polymer actuator and housing assembly;

FIGS. 13A and 13B illustrate an example of driving a haptic signal using a zero-crossing configuration from an audio signal;

FIG. 14A illustrates an example of a power supply for a photoflash controller;

FIG. 14B illustrates a second example circuit comprising a push-pull metal-oxide-semiconductor field-effect transistor (MOSFET) array with closed loop feedback; and

FIG. 14C illustrates one example of schematics for a circuit design to drive the haptic assembly coupled to an electronic media device.

### DETAILED DESCRIPTION OF THE INVENTION

The devices, systems and methods of the present invention are now described in detail with reference to the accompanying figures.

It is noted that the figures discussed herein schematically illustrate exemplary configurations of devices that employ electroactive polymer (“EAP”) films or transducers having such EAP films. Many variations arc within the scope of this disclosure, for example, in variations of the device, the EAP transducers can be implemented to move a mass to produce an inertial haptic sensation. Alternatively, the EAP transducer can produce movement in the electronic media device when coupled to the assembly described herein.

In any application, the feedback displacement created by the EAP transducer can be exclusively in-plane which is sensed as lateral movement, or can be out-of-plane (which is sensed as vertical displacement). Alternatively, the EAP transducer material may be segmented to provide independently addressable/movable sections so as to provide angular displacement of the housing or electronic media device or combinations of other types of displacement. In addition, any number of EAP transducers or films (as disclosed in the applications and patent listed herein) can be incorporated in the user interface devices described herein.

The EAP transducer may be configured to displace to an applied voltage, which facilitates programming of a control system used with the subject tactile feedback devices. EAP transducers are ideal for such applications for a number of reasons. For example, because of their light weight and minimal components, EAP transducers offer a very low profile and, as such, are ideal for use in sensory/haptic feedback applications.

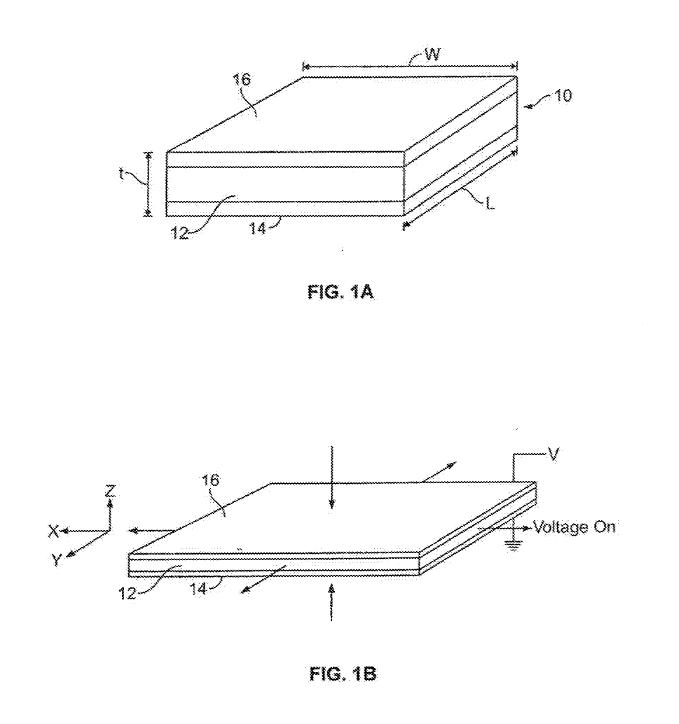

FIGS. 1A and 1B illustrate an example of an EAP film or membrane 10 structure. A thin elastomeric dielectric film or layer 12 is sandwiched between compliant or stretchable electrode plates or layers 14 and 16, thereby forming a capacitive structure or film. The length “l” and width “w” of the dielectric layer, as well as that of the composite structure, are much greater than its thickness “t”. Typically, the dielectric layer has a thickness in range from about 10 μm to about 100 μm, with the total thickness of the structure in the range from about 15 μm to about 10 cm. Additionally, it is desirable to select the elastic modulus, thickness, and/or the geometry of electrodes 14, 16 such that the additional stiffness they contribute to the actuator is generally less than the stiffness of the dielectric layer 12, which has a relatively low modulus of elasticity, i.e., less than about 100 MPa and more typically less than about 10 MPa, but is likely thicker than each of the electrodes. Electrodes suitable for use with these compliant capacitive structures are those capable of withstanding cyclic strains greater than about 1% without failure due to mechanical fatigue.

As seen in FIG. 1B, when a voltage is applied across the electrodes, the unlike charges in the two electrodes 14, 16 are attracted to each other and these electrostatic attractive forces compress the dielectric film 12 (along the Z-axis). The dielectric film 12 is thereby caused to deflect with a change in electric field. As electrodes 14, 16 are compliant, they change shape with dielectric layer 12. Generally speaking, deflection refers to any displacement, expansion, contraction, torsion, linear or area strain, or any other deformation of a portion of dielectric film 12. Depending on the architecture, e.g., a frame, in which capacitive structure 10 is employed (collectively referred to as a “transducer”), this deflection may be used to produce mechanical work. Various different transducer architectures arc disclosed and described in the above-identified patent references.

With a voltage applied, the transducer film 10 continues to deflect until mechanical forces balance the electrostatic forces driving the deflection. The mechanical forces include elastic restoring forces of the dielectric layer 12, the compliance or stretching of the electrodes 14, 16 and any external resistance provided by a device and/or load coupled to transducer 10. The resultant deflection of the transducer 10 as a result of the applied voltage may also depend on a number of other factors such as the dielectric constant of the elastomeric material and its size and stiffness. Removal of the voltage difference and the induced charge causes the reverse effects.

In some cases, the electrodes 14 and 16 may cover a limited portion of dielectric film 12 relative to the total area of the film. This may be done to prevent electrical breakdown around the edge of the dielectric or achieve customized deflections in certain portions thereof. Dielectric material outside an active area (the latter being a portion of the dielectric material having sufficient electrostatic force to enable deflection of that portion) may be caused to act as an external spring force on the active area during deflection. More specifically, material outside the active area may resist or enhance active area deflection by its contraction or expansion.

The dielectric film 12 may be pre-strained. The pre-strain improves conversion between electrical and mechanical energy, i.e., the pre-strain allows the dielectric film 12 to deflect more and provide greater mechanical work. Pre-strain of a film may be described as the change in dimension in a direction after pre-straining relative to the dimension in that direction before pre-straining. The pre-strain may comprise elastic deformation of the dielectric film and be formed, for example, by stretching the film in tension and fixing one or more of the edges while stretched. The pre-strain may be imposed at the boundaries of the film or for only a portion of the film and may be implemented by using a rigid frame or by stiffening a portion of the film.

The transducer structure of FIGS. 1A and 1B and other similar compliant structures and the details of their constructs are more fully described in many of the referenced patents and publications disclosed herein.

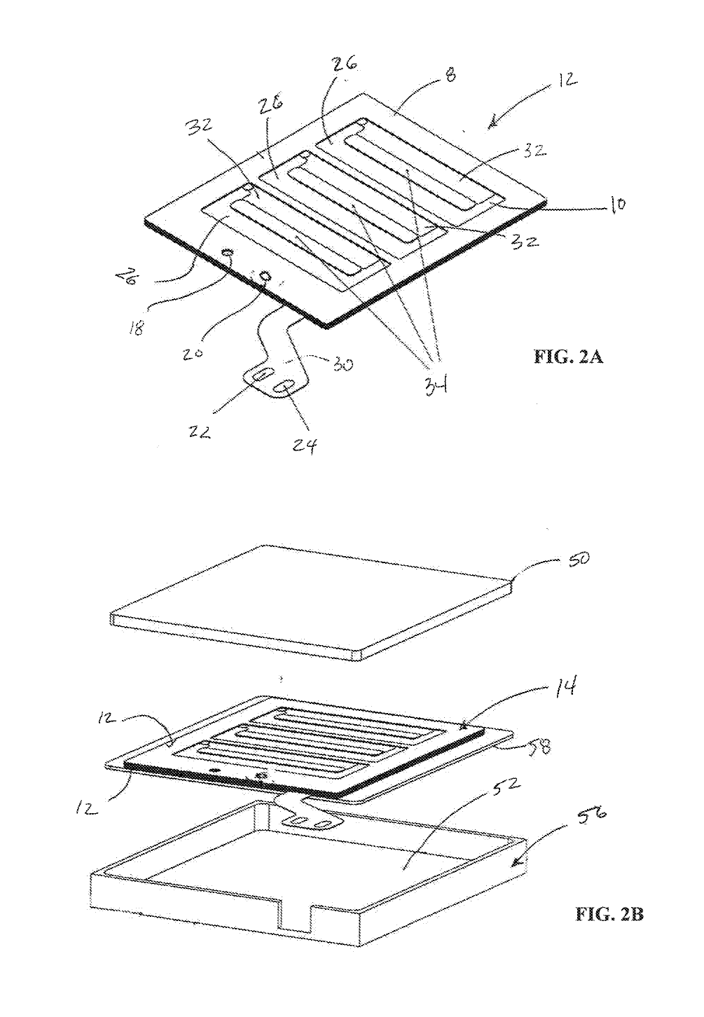

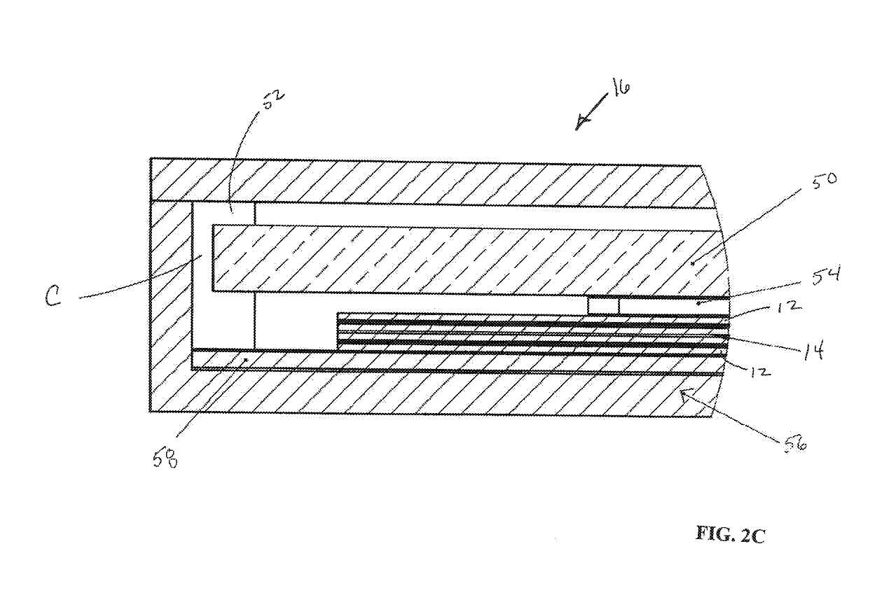

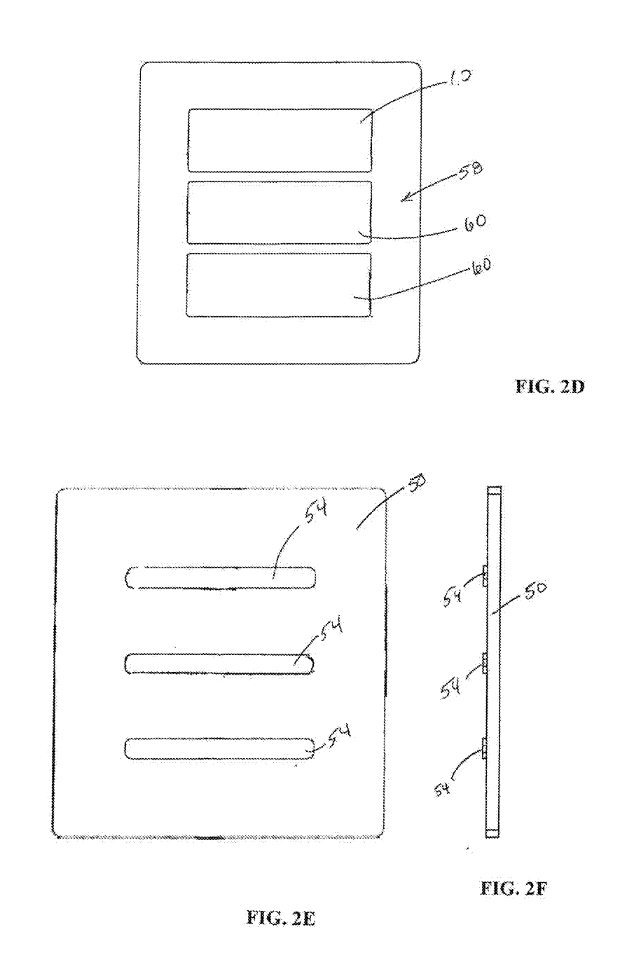

FIG. 2A illustrates an exemplary EAP polymer cartridge 12 having an EAP transducer film 26 placed between rigid frame 8 where the EAP film 26 is exposed in openings of the frame 8. The exposed portion of the film 26 includes two working pairs of thin elastic electrodes 32 on either side of the cartridge 12 where the electrodes 32 sandwich or surround the exposed portion of the film 26. The EAP film 26 can have any number of configurations. However, in one example, the EAP film 26 comprises a thin layer of elastomeric dielectric polymer (e.g., made of acrylate, silicone, urethane, thermoplastic elastomer, hydrocarbon rubber, fluororelastomer, copolymer elastomer, or the like). When a voltage difference is applied across the oppositely-charged electrodes 32 of each working pair (i.e., across paired electrodes that are on either side of the film 26), the opposed electrodes attract each other thereby compressing the dielectric polymer layer 26 therebetween. The area between opposed electrodes is considered the active area. As the electrodes are pulled closer together, the dielectric polymer 26 becomes thinner (i.e., the z-axis component contracts) as it expands in the planar directions (i.e., the x- and y-axes components expand) (see FIG. 1B for axis references). Furthermore, in variations where the electrodes contain conductive particles, like charges distributed across each electrode may cause conductive particles embedded within that electrode to repel one another, thereby contributing to the expansion of the elastic electrodes and dielectric films. In alternate variations, electrodes do not contain conductive particles (e.g., textured sputtered metal films). The dielectric layer 26 is thereby caused to deflect with a change in electric field. As the electrode material is also compliant, the electrode layers change shape along with dielectric layer 26. Generally speaking, deflection refers to any displacement, expansion, contraction, torsion, linear or area strain, or any other deformation of a portion of dielectric layer 26. This deflection may be used to produce mechanical work. As shown, the dielectric layer 26 can also include one or more mechanical output bars 34. The bars 34 can optionally provide attachment points for either an inertial mass (as described below) or for direct coupling to the electronic media device.

In fabricating a transducer, an elastic film 26 can be stretched and held in a pre-strained condition by a rigid frame 8. In those variations employing a 4-sided frame, the film can be stretched bi-axially. It has been observed that the pre-strain improves the dielectric strength of the polymer layer 26, thereby improving conversion between electrical and mechanical energy, i.e., the pre-strain allows the film to deflect more and provide greater mechanical work. Typically, the electrode material is applied after pre-straining the polymer layer, but may be applied beforehand. The two electrodes provided on the same side of layer 26, referred to herein as same-side electrode pairs, i.e., electrodes on the top side of dielectric layer 26 and electrodes on a bottom side of dielectric layer 26, can be electrically isolated from each other. The opposed electrodes on the opposite sides of the polymer layer form two sets of working electrode pairs, i.e., electrodes spaced by the EAP film 26 form one working electrode pair and electrodes surrounding the adjacent exposed EAP film 26 form another working electrode pair. Each same-side electrode pair can have the same polarity, while the polarity of the electrodes of each working electrode pair are opposite each other. Each electrode has an electrical contact portion configured for electrical connection to a voltage source.

In this variation, the electrodes 32 are connected to a voltage source via a flex connector 30 having leads 22, 24 that can be connected to the opposing poles of the voltage source. The cartridge 12 also includes conductive vias 18, 20. The conductive vias 18, 20 can provide a means to electrically couple the electrodes 8 with a respective lead 22 or 24 depending upon the polarity of the electrodes.

The cartridge 12 illustrated in FIG. 2A shows a three-bar actuator configuration. However, the devices and methods described herein are not limited to any particular configuration, unless specifically claimed. Typically, the number of the bars 34 depends on the active area desired for the intended application. The total amount of active area e.g., the total amount of area between electrodes can be varied depending on the mass that the actuator is trying to move and the desired frequency of movement. In one example, selection of the number of bars is determined by first assessing the size of the object to be moved, then the mass of the object is determined. The actuator design is then obtained by configuring a design that will move that object at the desired frequency range. Clearly, any number of actuator designs is within the scope of the disclosure.

An electroactive polymer actuator for use in the methods and devices described herein can then be formed in a number of different ways. For example, the electroactive polymer can be formed by stacking a number of cartridges 12 together, having a single cartridge with multiple layers, or having multiple cartridges with multiple layers. Typically, manufacturing and yield considerations favor stacking single cartridges together to form the electroactive polymer actuator. In doing so, electrical connectivity between cartridges can be maintained by electrically coupling the vias 18, 20 together so that adjacent cartridges are coupled to the same voltage source or power supply.

The cartridge 12 shown in FIG. 2A includes three pairs of electrodes 32 separated by a single dielectric layer 26. In one variation, as shown in FIG. 2B, two or more cartridges 12 are stacked together to form an electroactive actuator 14 that is coupled to an inertial mass 50. Alternatively, the electroactive actuator 14 can be coupled directly to the electronic media device through a temporary attachment plate or frame. As discussed below, the electroactive actuator 14 can be placed within a cavity 52 that allows for movement of the actuator as desired. The pocket 52 can be directly formed in a housing of a haptic case. Alternatively, pocket 52 can he formed in a separate case 56 that is positioned within the housing of the device. If the latter, the material properties of the separate case 56 can be selected based upon the needs of the actuator 14. For example, if the main body of the haptic housing assembly is flexible, the separate case 56 can be made rigid to provide protection to the electroactive actuator and/or the mass 50. In any event, variations of the device and methods described herein include size of the cavity 52 with sufficient clearance to allow movement of the actuator 14 and/or mass 50 but a close enough tolerance so that the cavity 52 barrier (e.g., the haptic housing or separate case 56) serves as a limit to prevent excessive movement of the electroactive actuator 14. Such a feature prevents the active areas of the actuator 14 from excessive displacement that can shorten the life of the actuator or otherwise damage the actuator.

FIG. 2C illustrates a partial cross sectional view of an actuator component housing 16 comprising an electroactive actuator 14 located within a cavity 52. In this example, the electroactive actuator 14 comprises two stacked cartridges 12. The actuator 14 can include one or more actuator spacers 58 and one or more mass spacers 54. The spacers 54 and 58 can have recesses or raised surfaces that are aimed to facilitate unhindered movement of the active area of the actuators 14 within the device or case 56. For example, the inertial mass 50 can be coupled to the actuator bars 34 of the transducer 14 while being separated from the remaining non-moving portion of the actuator 14. Furthermore, FIG. 2C illustrates the clearance C between the inertial mass 50 and a wall of the separate case 56, which allows a perimeter of the interior cavity 52 to serve as a barrier or hard stop or bumper for the actuator and/or mass.

FIG. 2D, illustrates a planar view of an actuator spacer 58. In this variation, the actuator spacer 58 includes a series of recesses or cutouts 60. These cutouts 60 align with the movable portions of the actuator (i.e., the dielectric surrounded by the output bars 34) so as to allow unimpeded movement of the active portion of the actuator.

FIGS. 2E and 2F illustrate a bottom view and side view of an inertial mass 50. As shown, the inertial mass 50 can include a number of spacers 54. The spacers 54 can be coupled to the output bars 34 of the actuator so that the moving surface of the mass 50 does not engage the non-moving surface of the actuator 14. Furthermore, the mass spacer 54 can couple the inertial mass 50 to the output bars 34 of the actuator 14.

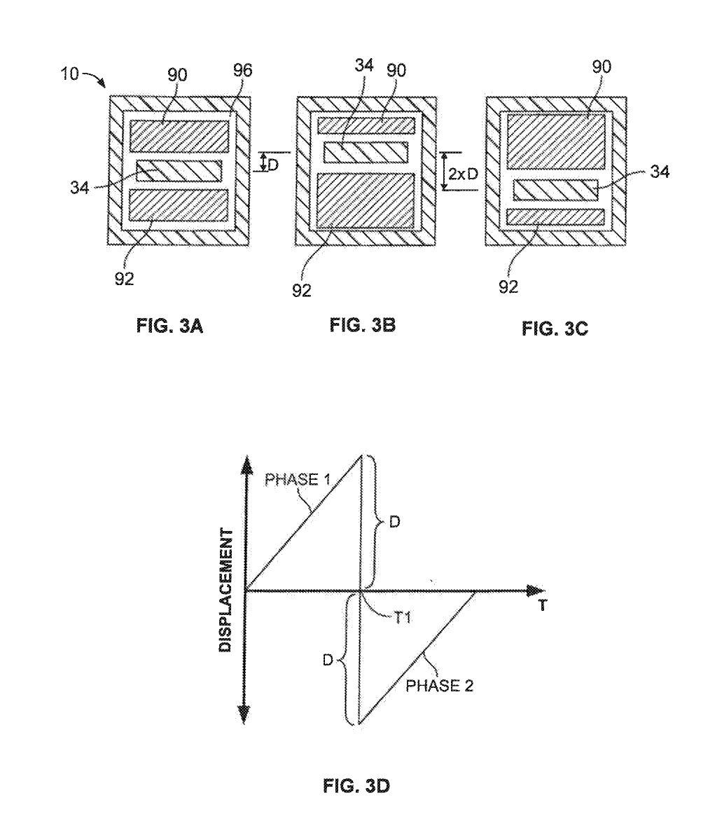

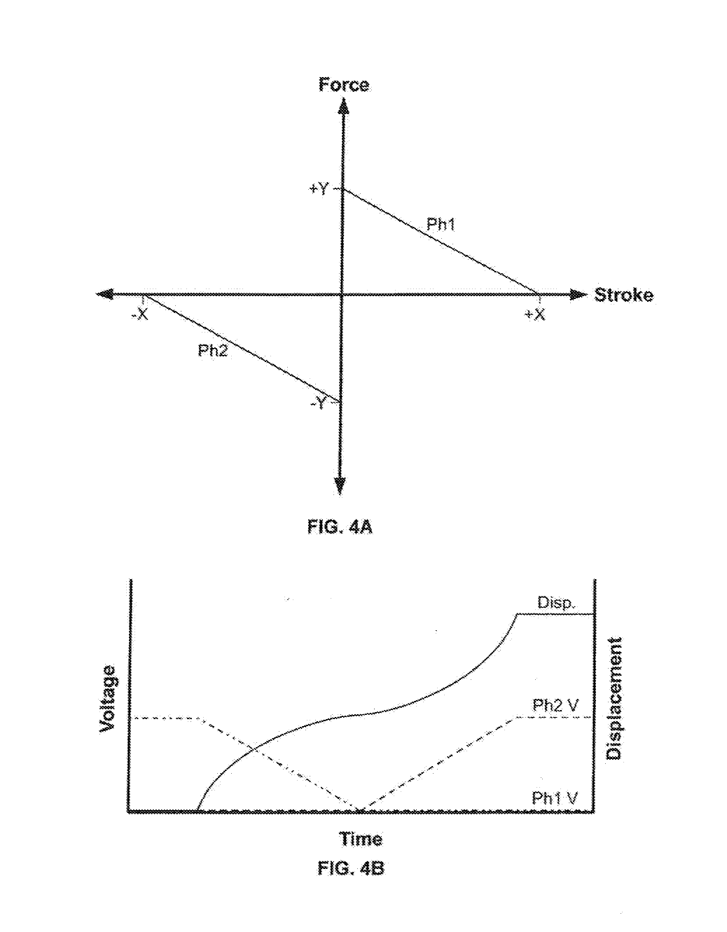

FIGS. 3A to 3C illustrate another variation of a two-phase electroactive polymer transducer. In this variation, the transducer 10 comprises a first pair of electrodes 90 about the dielectric film 96 and a second pair of electrodes 92 about the dielectric film 96 where the two pairs of electrodes 90 and 92 are on opposite sides of a bar or mechanical member 34 that facilitates coupling to another structure to transfer movement. As shown in FIG. 3A, both electrodes 90 and 92 are at the same voltage (e.g., both being at a zero voltage). In the first phase, as illustrated in FIG. 3B, one pair of electrodes 92 is energized to expand the film and move the bar 34 by a distance D. The second pair of electrodes 90 is compressed by nature of being connected to the film but is at a zero voltage. FIG. 3C shows a second phase in which the voltage of the first pair of electrodes 92 is reduced or turned off while voltage is applied to the second pair of electrodes 90 is energized. This second phase is synchronized with the first phase so that the displacement is greater than D (as much as 2 times D). FIG. 3D illustrates the displacement of the transducer 10 of FIGS. 3A to 3C over time. As shown, Phase 1 occurs as the bar 34 is displaced by amount D when the first electrode 92 is energized for Phase 1. At time T1 the beginning of Phase 2 occurs and the opposite electrode 90 is energized in synchronization with the reduction of the voltage of the first electrode 92. The net displacement of the bar 34 over the two phases is 2×D.

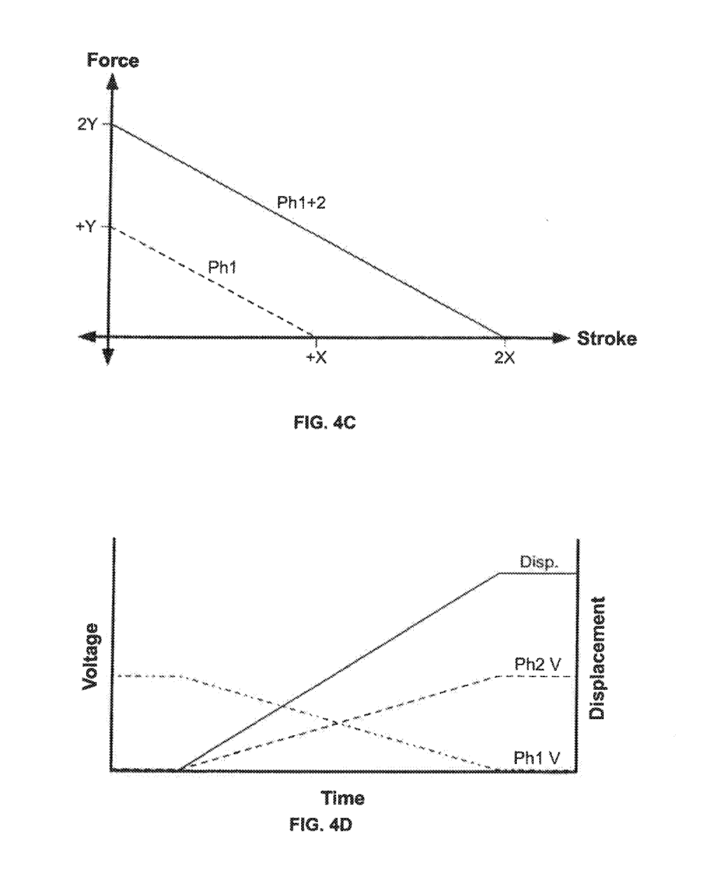

Depending upon the electrode configurations, the electroactive actuators 14 can be capable of functioning in either a single or a dual-phase mode (also known as a two-phase mode). When operating as a single mode actuator only one set of working pairs of electrodes of actuator 14 would be activated at any one time. In a configuration that includes multiple areas of active electrodes (like those shown in FIG. 2A) each set of electrodes is activated at the same time to cause movement of the output bars in the same direction. The single-phase operation of actuator 14 may be controlled using a single high voltage power supply. As the voltage applied to the single set of working electrode pairs is increased, the activated portion (one half) of the transducer film will expand, thereby moving the output member 34 in-plane in the direction of the inactive portion of the transducer film. FIG. 4A illustrates the force-stroke relationship of the sensory feedback signal (i.e., output member displacement) of actuator 30 relative to neutral position when alternatingly activating the two working electrode pairs in dual-phase mode. As illustrated, the respective forces and displacements of the output bars are equal to each other but in opposite directions (e.g., one pair of electrodes expands the polymer film while the other pair contracts the film).

FIG. 4B illustrates the resulting non-linear relationship of the applied voltage to the output displacement of the actuator when operated in this dual-phase mode. The “mechanical” coupling of the two electrode pairs by way of the shared dielectric film may be such as to move the output disc in opposite directions. Thus, when both electrode pairs are operated, albeit independently of each other, application of a voltage to the first working electrode pair (phase 1) will move the output disc 20 in one direction, and application of a voltage to the second working electrode pair (phase 2) will move the output disc 20 in the opposite direction. As the various plots of FIG. 4C reflect, as the voltage is varied linearly, the displacement of the actuator is non-linear. The acceleration of the output disk during displacement can also be controlled through the synchronized operation of the two phases to enhance the haptic feedback effect. The actuator can also be partitioned into more than two phases that can be independently activated to enable more complex motion of the output disk. Two-phase mode allows for a greater displacement and faster acceleration of the output bar 34, and thus provide a greater sensory feedback signal to the user. A two-phase mode allows activating both portions of the actuator simultaneously. FIG. 4C illustrates the force-stroke relationship of the sensory feedback signal of the output disc when the actuator is operated in two-phase mode. As illustrated, both the force and stroke of the two portions 90, 92 of the actuator in this mode produce movement of the output bar 34 in the same direction and have double the magnitude than the force and stroke of the actuator when operated in single-phase mode. FIG. 4D illustrates the resulting linear relationship of the applied voltage to the output displacement of the actuator when operated in this two-phase mode.

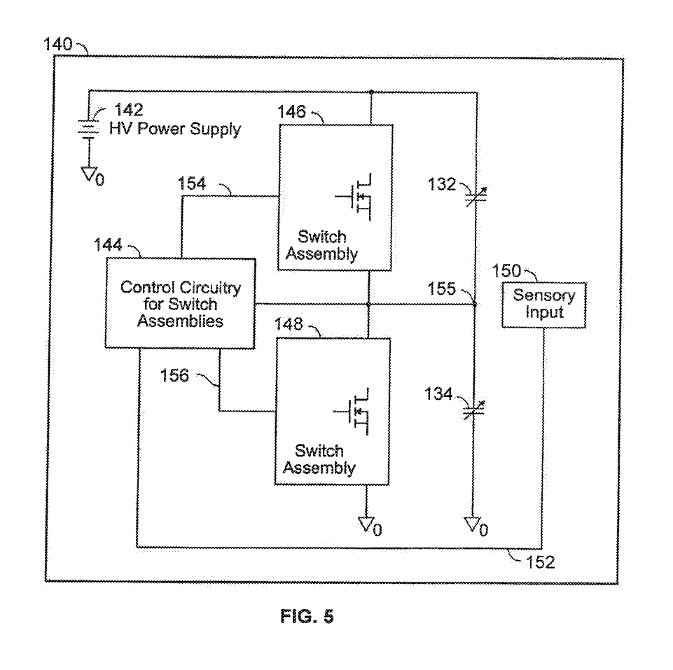

By connecting the mechanically coupled portions 90, 92 of the actuator electrically in series and controlling their common node 155, such as in the manner illustrated in the block diagram 140 of FIG. 5, the relationship between the voltage of the common node 155 and the displacement (or blocked force) of the output member (in whatever configuration) approach a linear correlation. In this mode of operation, the non-linear voltage responses of the two portions 90, 92 of actuator effectively cancel each other out to produce a linear voltage response. With the use of control circuitry 144 and switching assemblies 146, 148, one for each portion of the actuator, this linear relationship allows the performance of the actuator to be fine-tuned and modulated by the use of varying types of waveforms supplied to the switch assemblies by the control circuitry. Another advantage of using circuit 140 is the ability to reduce the number of switching circuits and power supplies needed to operate the sensory feedback device. Without the use of circuit 140, two independent power supplies and four switching assemblies would be required. Thus, the complexity and cost of the circuitry are reduced while the relationship between the control voltage and the actuator displacement are improved, i.e., made more linear. Another advantage is that during two-phase operation, the actuator obtains synchronicity, which eliminates delays that could reduce performance.

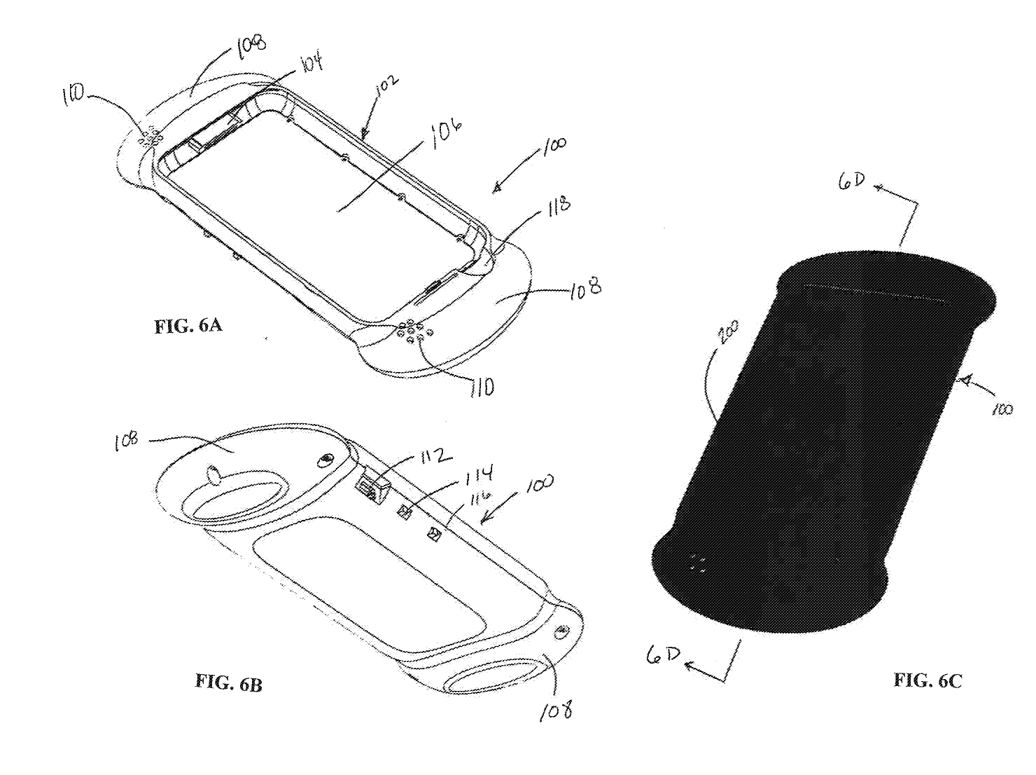

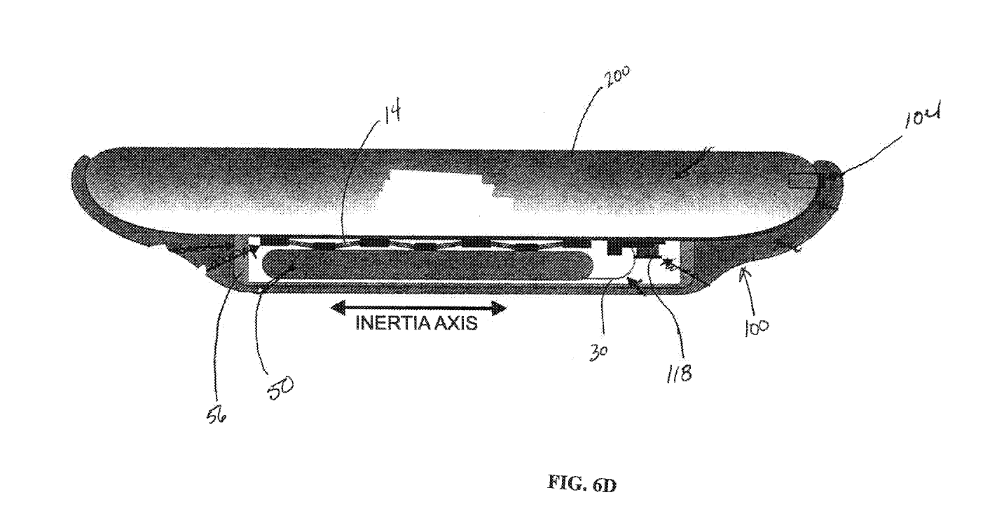

FIG. 6A illustrates one example of a housing assembly 100 for removably coupling with an electronic media device that is configured to deliver an output signal to an output port. The housing assembly produces a haptic effect in response to the output signal of the electronic media device. Clearly, the housing assembly 100 can be used with any electronic media devices such as smart phones, personal media players, portable computing devices, portable gaming systems, electronic readers, etc. Moreover, the term electronic media devices can include such components as remote controls, GPS units, scanners, personal digital assistants, diagnostic equipment, electronic peripherals (e.g., mice, gaming controllers, etc.) or any such electronic equipment that can benefit from an improved haptic response given an output signal from the device. Often such devices are hand-held, though the application is not limited to such hand-held devices unless specifically claimed. In certain variations, the assemblies described herein, along with the methods and systems, can be coupled to devices 200 that are fully functional in a stand-alone mode. In such a case, the housing assembly 100 only serves to improve or augment haptic or other output from the device 200.

In the illustrated variation, the housing assembly 100 includes a housing or case 102 adapted to nest at least a portion of electronic media device (200 as shown in FIG. 6C). The housing can include one or more one media device connectors 104 adapted to detachably couple to an output port or speaker jack of the electronic media device 200. In most cases, the output port of the media device 200 comprises a USB port, dock port, or other connector that allows both input to and output from the media device 200. In certain cases, the assembly 100 is coupled via a speaker output that only provides output from the media device 200. In any case, the term output port is meant to include ports that allow for input and output, or output alone.

The housing case 102 can comprise a flexible or textured sleeve to provide improved handing grip and ruggedness to the media device. Alternatively, the housing case 102 can comprise a rigid material to provide added protection to the device. The media device 200 nests within a pocket or cavity 106. To accommodate placement, the media device connector 104 can swivel or articulate to allow for ease of coupling the media device 200 to the case 102. FIG. 6A also illustrates optional components for the housing assembly 100. For example, the housing assembly can include one or more handles 108 to aid in maneuvering the device 200 without covering a screen or other portion of the device 200. Furthermore, the housing assembly 100 can include one or more speakers 110. In such a case, the output signal of the device 200 can be split between drive circuitry that controls the electroactive polymer actuator and the speakers 110 of the housing assembly 100. Although not shown, the electroactive polymer actuator can reside beneath a surface of the cavity 106.

FIG. 6B illustrates a bottom perspective view of the housing assembly 100 of FIG. 6A. As shown, the handles 108 can include flat surfaces or other features to aid in handling or placement of the assembly 100 and device 200. The housing also can optionally include one or more input/output jacks 112. For example, such input/output jacks can accommodate any variation of a USB connector to allow for charging of a power supply coupled to the actuator. Alternatively, or in combination, the jack 112 can provide a pass-through to the media device 200 so that the media device 200 can be charged or allow for data transfer without the need to remove it from the housing assembly 100. FIG. 6B also illustrates that the housing assembly 100 can include any number of controls 114, 116 so that the operator can adjust audio, haptics, or other features of the device 200 and/or assembly 100. FIG. 6A also illustrates that the housing case 102 can include features 118 so that controls on the media device 200 can be adjusted without necessarily removing the device 200 from the case 102. In this example, the feature 118 comprises a recess so that a power toggle can be manipulated on the media device 200. In most cases, the shape of the case 102 as well as the cavity 106 will be customized for the particular make and model of the media device 200. Accordingly, any number of such features 118 that permit control of the media device 200 while coupled to the case 102 are considered to be within the scope of this disclosure

FIG. 6C illustrates an electronic media device 200 (in this example, an IPOD TOUCH) removably coupled with a housing assembly 100 that can convert an output signal from the iPod into an increased haptic effect that can be felt by the user either at the body case 102, the handles 110 and/or the device 200.

FIG. 6D shows a representation of a view as taken along the line 6D-6D in FIG. 6C. As discussed above, the housing assembly 100 includes at least one electroactive polymer actuator 14 having an active portion configured to produce movement in response to a triggering signal from the electronic media device 200. Movement of the active portion creates the haptic effect discernable on or at the housing assembly 100 (optionally including at the device 200 itself). The triggering signal can be the ordinary output of the media device 200 or can comprise custom software that is incorporated into the media device. The device 200 can optionally power the electroactive polymer actuator 14. Alternatively, the housing assembly 100 can include a separate power supply that powers the electroactive actuator 14. Optionally, the housing assembly 100 includes an inertial mass 50 that is driven by the actuator 14 to produce the haptic effect. In some variations, the separate power supply can be used as the inertial mass 50. In alternate variations, the housing assembly 100 includes both a separate power supply and a discrete inertial mass.

FIG. 6D also illustrates the housing 100 including at least one drive electronics assembly 118 configured to electronically couple the electroactive polymer actuator 14 (typically via a connector 30) to the media device connector 104, such that the drive electronics is capable of generating the triggering signal in response to the output signal of the electronic media device 200. As discussed above, FIG. 6D also illustrates the actuator 14 and inertial mass 50 as being contained within an actuator case 56. Again, the actuator case 56 can designed provide as a protective housing for the actuator 14. In one embodiment, the two piece assembly allows the same actuator case 56 to be inserted into different housings 100 to accommodate different device form factors. Thus, the bulk of the assembly (all parts contained in 56) can remain the same while the outside grip is changed to fit many device models/form factors. Alternatively, use of the housing 56 can allow a user to remove the actuator housing 56 containing the actuator 14 and inertial mass 50 and replace it with an alternate actuator housing 56. The alternate actuator housing can provide the device with an electroactive polymer actuator having different characteristics or can provide the device with an entirely different functionality.

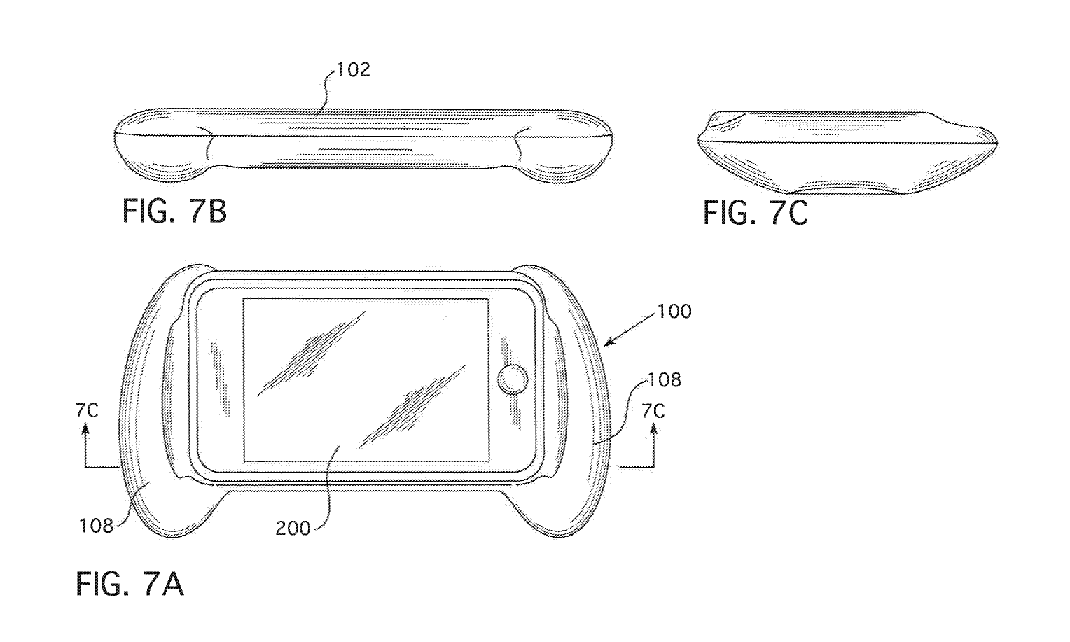

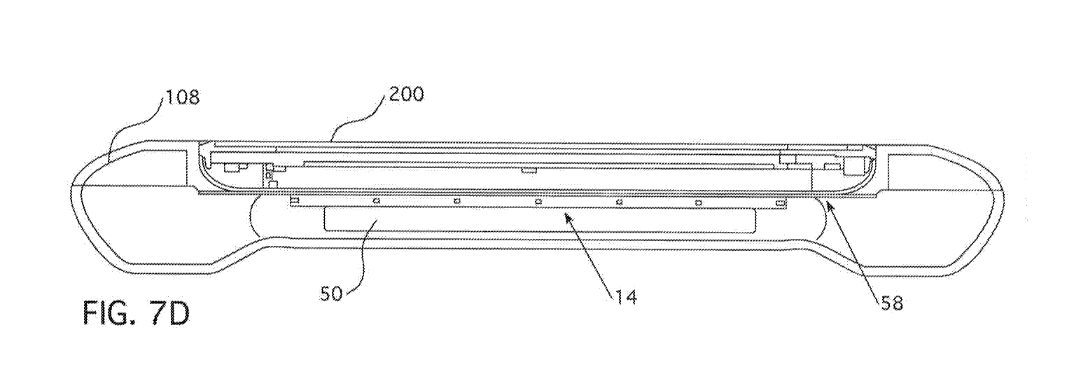

FIGS. 7A to 7C represent top, side, and right views of another variation of a housing assembly 100 capable of removably coupling with an electronic media device. In this variation, the case 102 of the housing assembly 100 includes a pair of symmetric handles 108 that converts the shape of the electronic media device 200 into a more conventional gaming device. The handles 108 form grips to permit use of the device 200 in a portrait mode and permit manipulation of the assembly 100 and device 200 without the need to obscure a viewing area of the device 200.

FIG. 7D shows a sectional view taken along the lines 7C-7C in FIG. 7A. In this variation, the actuator 14 and inertial mass 50 are directly coupled to a mounting plate 58 in the case 102 rather than using an actuator housing. It is noted that alternate variations of the device include omitting the inertial mass 50 to allow the actuator 14 to directly drive the media device 200. While the drive electronics are not illustrated in FIG. 7C, the circuitry can be positioned within the handles 108.

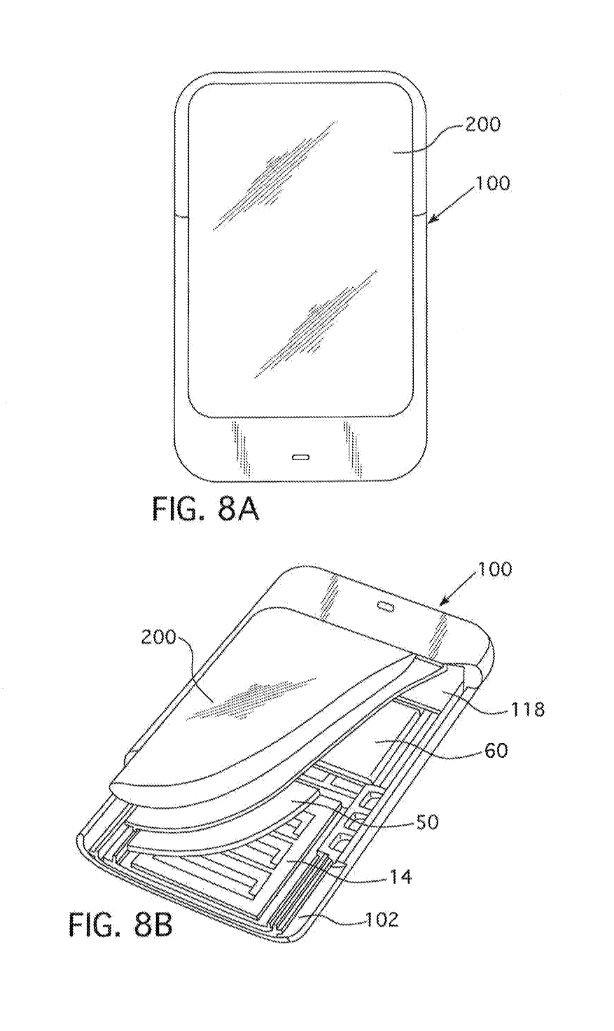

FIG. 8A shows another variation of a housing assembly 100 or haptic grip assembly for use with a media device 200. FIG. 8B shows a partial cut-away section of the assembly 100. In this variation, the assembly 100 includes a battery 60 that is separate from an inertial mass 50. As discussed above, the inertial mass 50 is coupled to an electroactive polymer actuator 14 located within the case 102. As with the variations shown above, the housing 100 can optionally isolate the battery 60 or power supply from the media device 200 so that the power supply 60 only powers the haptic transducer assembly 14 as well as any drive electronics 118 that converts an output signal from the media device 200 into a triggering signal that controls movement of the actuator 14 and the resulting haptic effect.

### Filtered Sound Drive Waveform for Electroactive Polymer Haptics

The methods and devices described herein can generate the haptic effect by a sound signal provided by the media device. Such a configuration eliminates the need for a separate processor to generate waveforms to produce different types of haptic sensations. Instead, haptic devices can employ one or more circuits to modify an existing audio signal into a modified haptic signal, e.g. filtering or amplifying different portions of the frequency spectrum. Therefore, the modified haptic signal then drives the actuator. In one example, the modified haptic signal drives the power supply to trigger the actuator to achieve different sensory effects. This approach has the advantages of being automatically correlated with and synchronized to any audio signal which can reinforce the feedback from the music or sound effects in a haptic device such as a gaming controller or handheld gaming console.

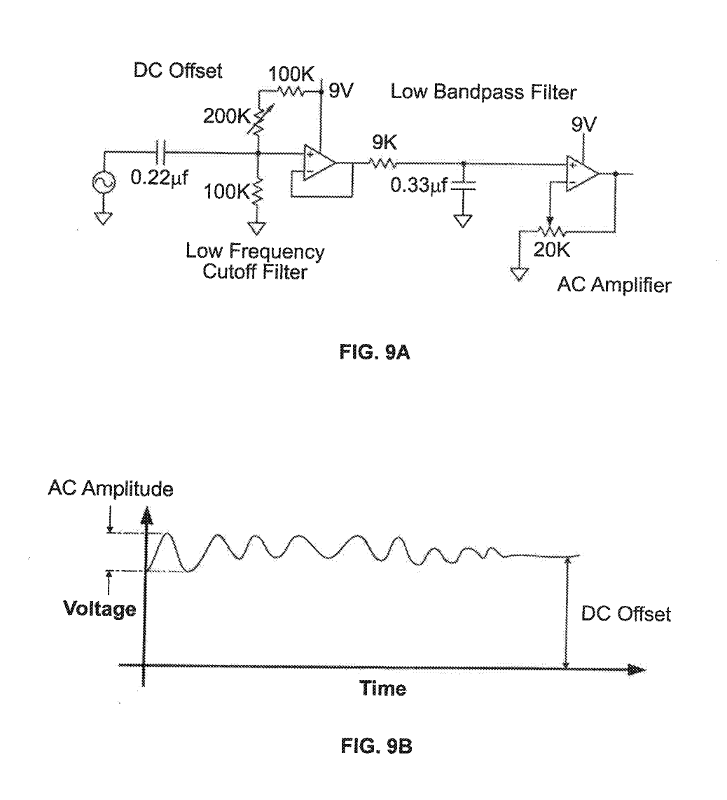

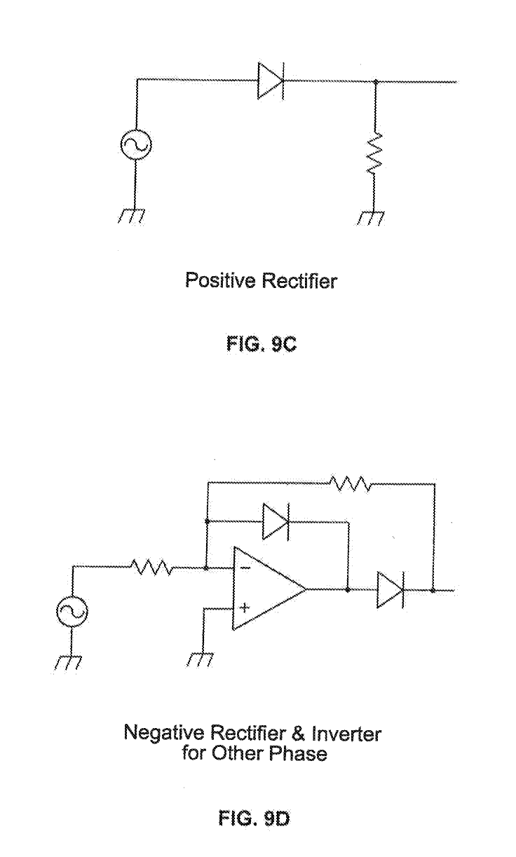

FIG. 9A illustrates one example of a circuit to tune an audio signal to work within optimal haptic frequencies for electroactive polymer actuators. The illustrated circuit modifies the audio signal by amplitude cutoff, DC offset adjustment, and AC waveform peak-to-peak magnitude adjustment to produce a signal similar to that shown in FIG. 9B. In certain variations, the electroactive polymer actuator comprises a two phase electroactive polymer actuator and altering the audio signal comprises filtering a positive portion of an audio waveform of the audio signal to drive a first phase of the electroactive polymer transducer and inverting a negative portion of the audio waveform of the audio signal to drive a second phase of the electroactive polymer transducer to improve performance of the electroactive polymer transducer. In another variation, a source audio signal in the form of a sine wave can be converted to a square wave (e.g., via clipping), so that the haptic signal is a square wave that produces maximum actuator force output.

In another example, the circuit can include one or more rectifiers to filter the frequency of an audio signal to use all or a portion of an audio waveform of the audio signal to drive the haptic effect. FIG. 9C illustrates one variation of a circuit designed to filter a positive portion of an audio waveform of an audio signal. This circuit can be combined, in another variation, with the circuit shown in FIG. 9D for actuators having two phases. As shown, the circuit of FIG. 9C can filter positive portions of an audio waveform to drive one phase of the actuator while the circuit shown in FIG. 9D can invert a negative portion of an audio waveform to drive the other phase of the two-phase haptic actuator. The result is that the two phase actuator will have a greater actuator performance.

In another implementation, a threshold in the audio signal can be used to trigger the operation of a secondary circuit which drives the actuator. The threshold can be defined by the amplitude, the frequency, or a particular pattern in the audio signal. The secondary circuit can have a fixed response such as an oscillator circuit set to output a particular frequency or can have multiple responses based on multiple defined triggers. In some variations, the responses can be pre-determined based upon a particular trigger. In such a case, stored response signals can he provided in upon a particular trigger. In this manner, instead of modifying the source signal, the circuit triggers a pre-determined response depending upon one or more characteristics of the source signal. The secondary circuit can also include a timer to output a response of limited duration.

Many systems could benefit from the implementation of haptics with capabilities for sound, (e.g. computers, smart phones, PDA's, electronic games). In this variation, filtered sound serves as the driving waveform for electroactive polymer haptics. The sound files normally used in these systems can be filtered to include only the optimal frequency ranges for the haptic feedback actuator designs.

Current systems operate at optimal frequencies of <200 Hz. A sound waveform, such as the sound of a shotgun blast, or the sound of a door closing, can be low pass filtered to allow only the frequencies from these sounds that are <200 Hz to be used. This filtered waveform is then supplied as the input waveform to the EPAM power supply that drives the haptic feedback actuator. If these examples were used in a gaming controller, the sound of the shotgun blast and the closing door would be simultaneous to the haptic feedback actuator, supplying an enriched experience to the game player.

In one variation use of an existing sound signal can allow for a method of producing a haptic effect in a user interface device simultaneously with the sound generated by the separately generated audio signal. For example, the method can include routing the audio signal to a filtering circuit; altering the audio signal to produce a haptic drive signal by filtering a range of frequencies below a predetermined frequency; and providing the haptic drive signal to a power supply coupled to an electroactive polymer transducer such that the power supply actuates the electroactive polymer transducer to drive the haptic effect simultaneously to the sound generated by the audio signal.

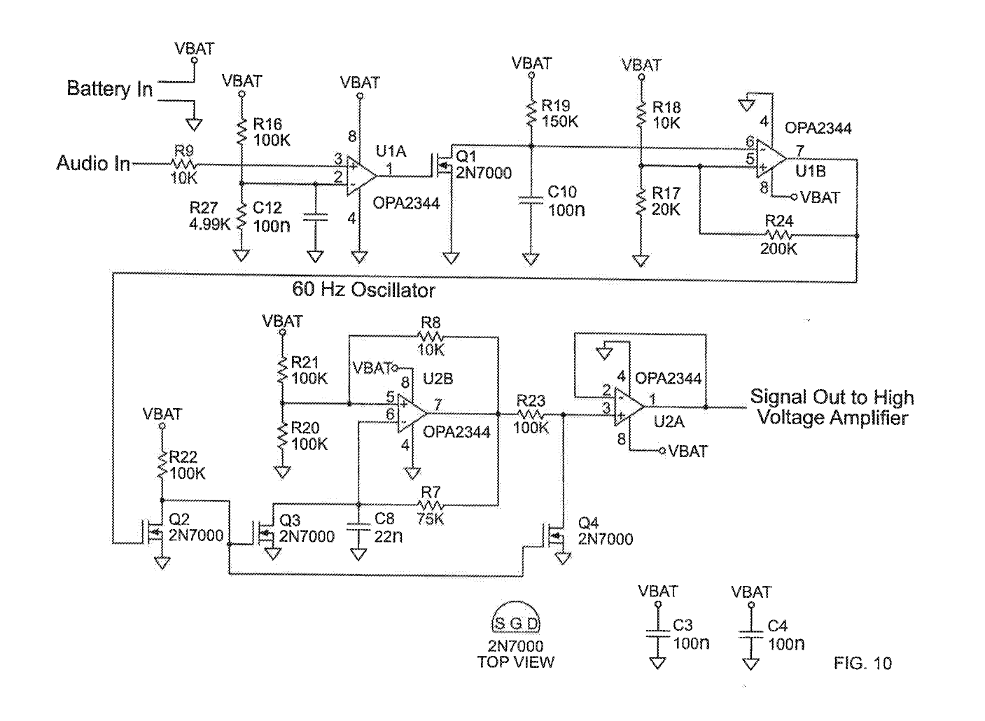

Another variation for driving an electroactive polymer transducer includes the use of stored wave forms given a threshold input signal. The input signal can include an audio or other triggering signal. For example, the circuit shown in FIG. 10 illustrates an audio signal serving as a trigger for a stored waveform. Again, the system can use a triggering or other signal in place of the audio signal. This method drives the electroactive polymer transducer with one or more pre-determined waveforms rather than using simply driving the actuator directly from the audio signal. One benefit of this mode of driving the actuator is that the use of stored waveforms enables the generation of complex waveforms and actuator performance with minimal memory and complexity. Actuator performance can be enhanced by using a drive pulse optimized for the actuator (e.g. running at a preferred voltage or pulse width or at resonance) rather than using the analog audio signal. The actuator response can be synchronous with the input signal or can he delayed. In one example, a 0.25 v trigger threshold can be used as the trigger. This low-level signal can then generate one or more pulse waveforms. In another variation, this driving technique can potentially allow the use of the same input or triggering signal to have different output signals based on any number of conditions (e.g., such as the position of the user interface device, the state of the user interface device, a program being run on the device, etc.).

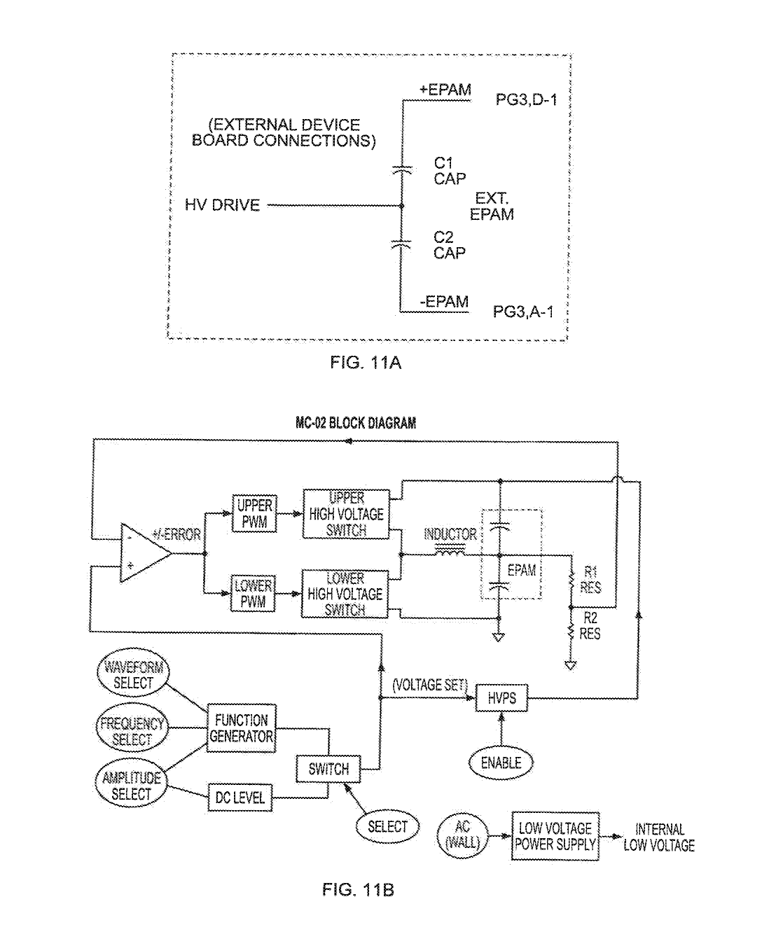

FIGS. 11A and 11B illustrate yet another variation for driving an electroactive polymer transducer by providing two-phase activation with a single drive circuit. As shown, of the three power leads in a two-phase transducer, one lead on one of the phases is held constant at high voltage, one lead on the other phase is grounded, and the third lead common to both phases is driven to vary in voltage from ground to high voltage. This enables the activation of one phase to occur simultaneously with the deactivation of the second phase to enhance the snap-through performance of a two-phase actuator.

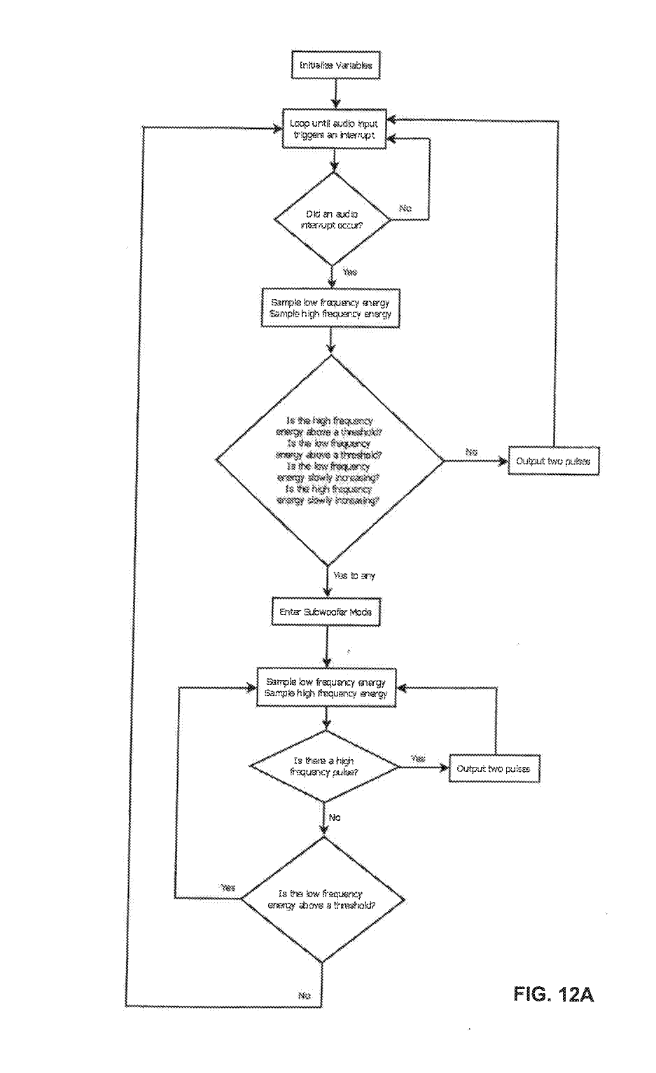

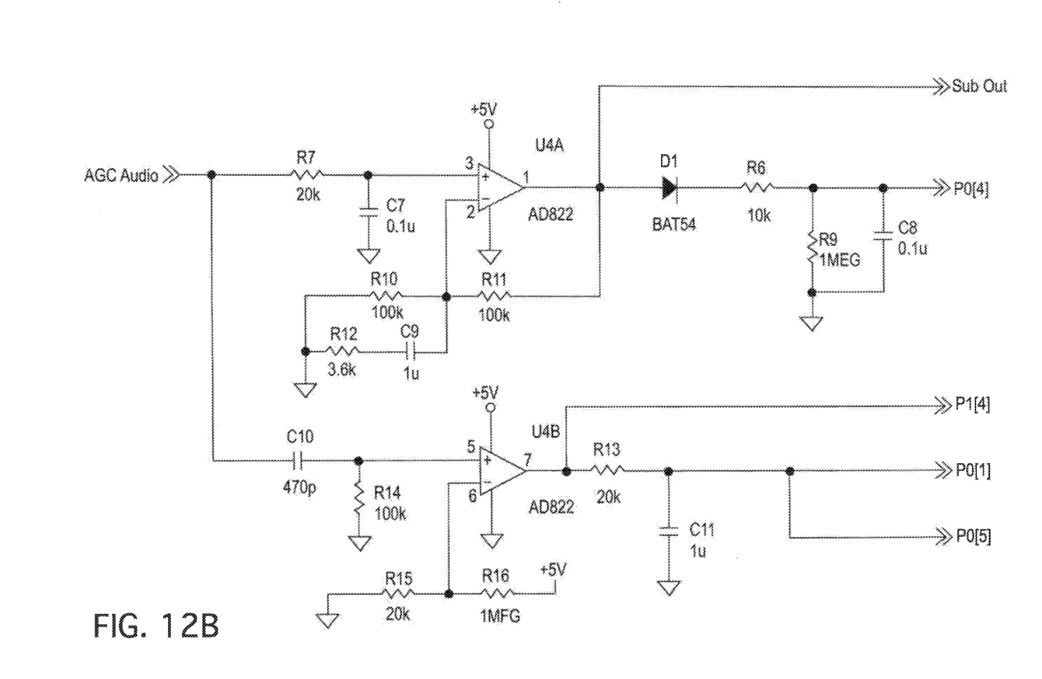

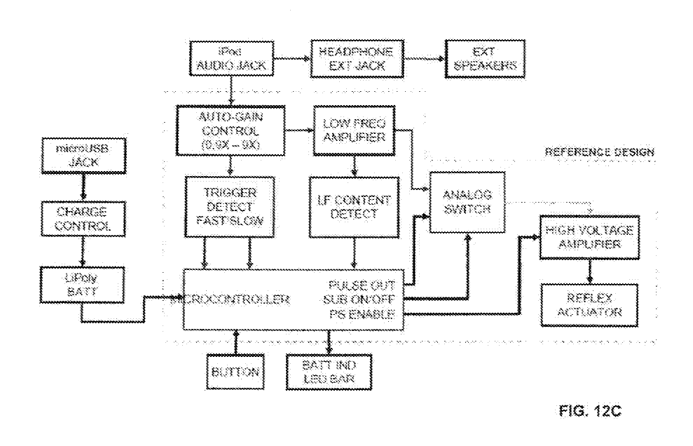

The electroactive polymer actuator used in the present disclosure can be controlled to operate between a pulse mode and a subwoofer mode depending upon the frequency of the signal output by the media device. Such a feature is useful to distinguish between repeatable effects (such as the typing on a keyboard) and effects produced during games or other by various other media. FIG. 12A illustrates one variation of a flow chart used to determine the actuator mode based on the input signal. FIG. 12B illustrates on possible example of a trigger circuit. FIG. 12C provides one example of the control architecture used for a variation of the electroactive polymer actuator and housing assembly as described above.

### Drive Schemes

In many cases, the system can limit power consumption using a circuit that cuts off or reduces voltage when the current draw is too high, e.g. at higher frequencies. In a first example, the second stage cannot run unless the input stage of the converter is above a given voltage. When the second stage initializes, the circuit causes the voltage on the first stage to drop and then drops out of the second stage if the input power is limited. At low frequencies, the haptic response follows the input signal. However, because high frequencies require more power, the response becomes clipped depending on the input power. Power consumption is one of the metrics needed to optimize the sub-assembly and drive design. Clipping the response in this manner conserves power.

In another variation, the drive scheme can employ amplitude modulation. For example, the actuator voltage can be driven at resonant frequency where the signal amplitude is scaled based on the input signal amplitude. This level is determined by the input signal, and the frequency is determined by the actuator design.

In another variation, the haptic response or effect can be tailored by the choice of the drive scheme, e.g. analog (as with the audio signal) or digital bursts or combinations of Filters or amplifiers can be used to enhance the frequencies in the input drive signal that leads to the highest performance of the actuators. This permits an increased sensitivity in the haptic response by the user and/or to accentuate the effect desired by the user. For example, the sub-assembly/system frequency response can be designed to match/overlap fast a fast Fourier transform taken of sound effects that are used as the drive input signal.

Another variation for producing a haptic effect involves the use of a roll-off filter. Such a filter allows attenuation of high frequencies that require a high power draw. To compensate for this attenuation, the sub-assembly can be designed to have its resonance at higher frequencies. The resonant frequency of the sub-assembly can be adjusted for example by changing the stiffness of the actuators (e.g. by changing the dielectric material, varying the thickness of the dielectric film, changing the type or thickness of the electrode material, changing the dimensions of the actuators), changing the number of cartridges in the actuator stack, changing the load or inertial mass on the actuators. Moving to thinner films or softer materials can move the cut-off frequency needed to meet a current/power limitation to higher frequencies. Clearly, adjustment of the resonance frequency can occur in any number of ways. The frequency response can also be tailored by using a mixture of actuator types.

Rather than using a simple follower circuit, a threshold can be used in the input drive signal to trigger a burst with an arbitrary waveform that requires less power. This waveform could be at a lower frequency and/or can be optimized with respect to the resonant frequency of the system—sub-assembly & housing—to enhance the response. In addition, the use of a delay time between triggers can also be used to control the power load.

### Zero-Crossing Power Control

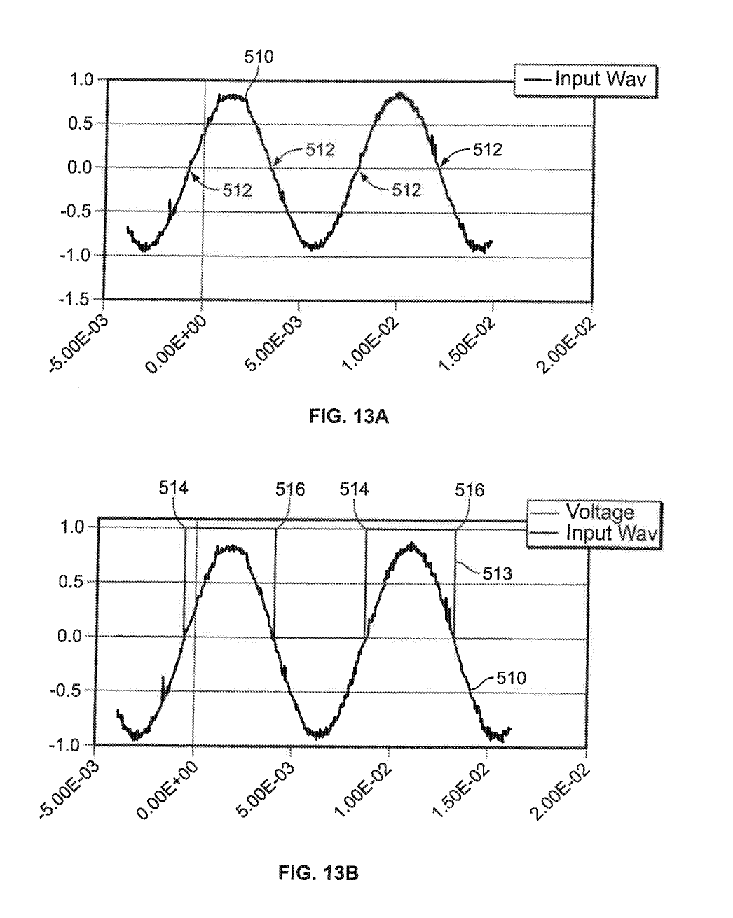

In another variation, a control circuit can monitor input audio waveforms and provide control for a high voltage circuit. In such a case, as shown in FIG. 13A, an audio waveform 510 is monitored for each transition through zero voltage value 512. With these zero crossings 512, a control circuit can indicate the crossing time value, and the voltage condition.

This control circuit changes high voltage based on zero crossing time and voltage swing direction. As shown in FIG. 13B, for zero crossing: positive swing, high voltage drive changes from zero volts to 1 kV (High Voltage Rail Value) at 514. For zero crossing: negative swing, high voltage drive changes from 1 kV to zero volts (Low Voltage Rail Value) at 516.

Such a control circuit allows actuation events to coincide with frequency of the audio signal 510. In addition, the control circuit can allow for filtering to eliminate higher frequency actuator events to maintain 40-200 Hz actuator response range. The square wave provides the highest actuation response for inertial drive designs and can be set by the limit of the power supply components. The charge up time can be adjusted to limit power supply requirements. To normalize actuation forces, the mechanical resonance frequency can be charged by a Triangle wave, while off resonant frequency actuations can be energized by a square wave.

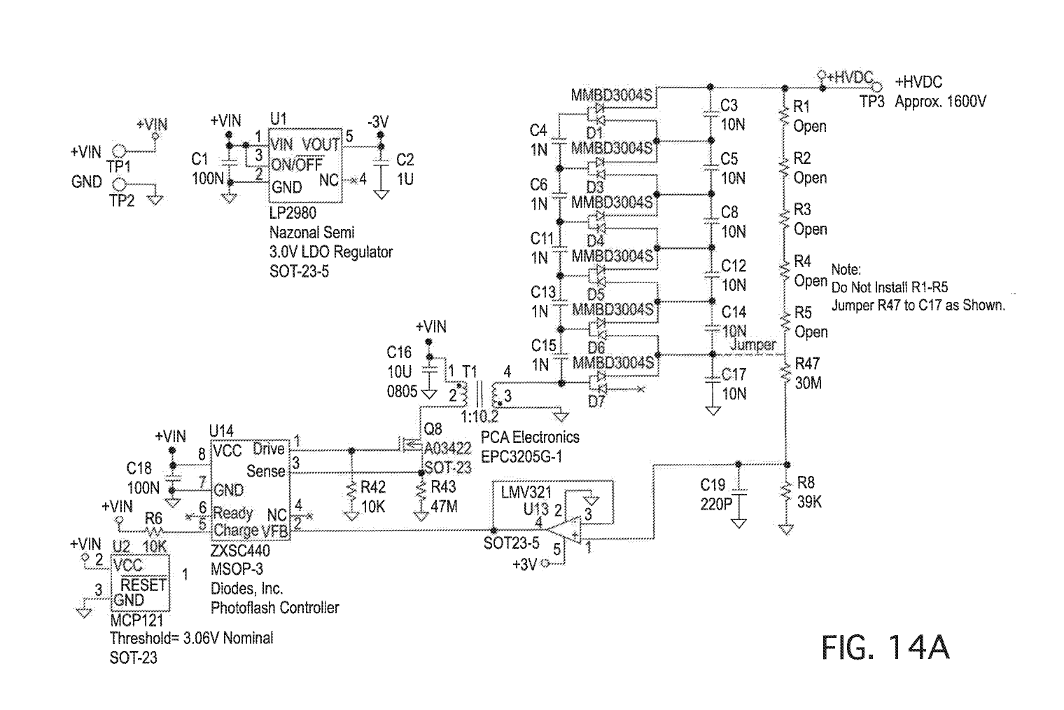

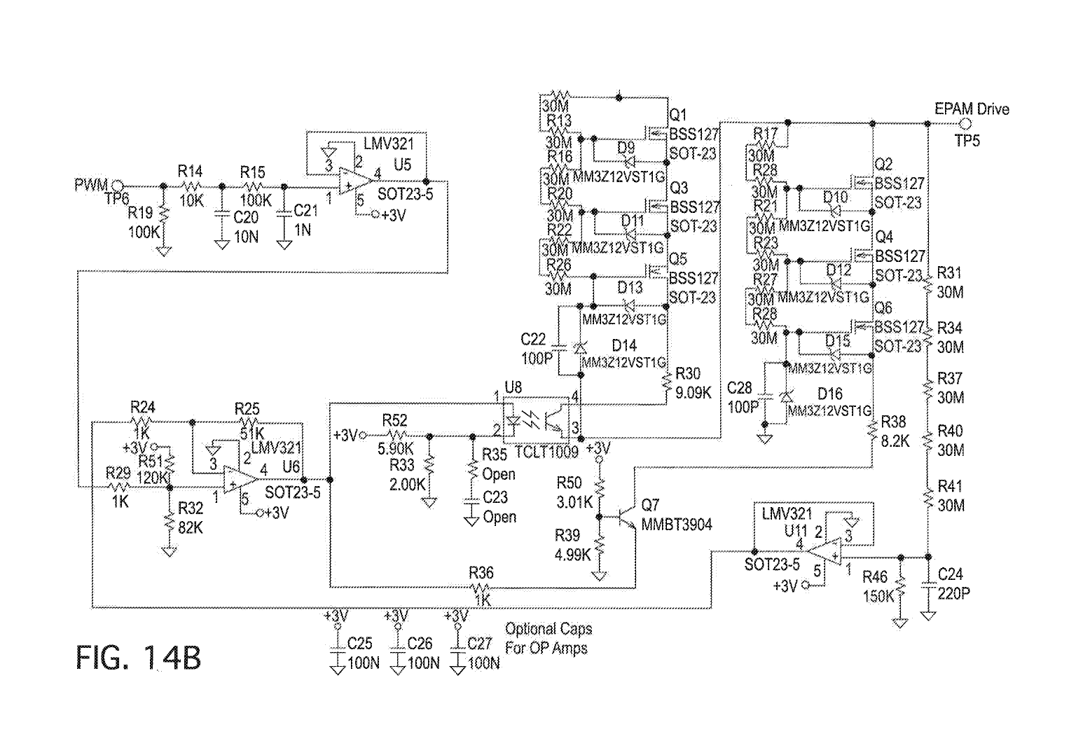

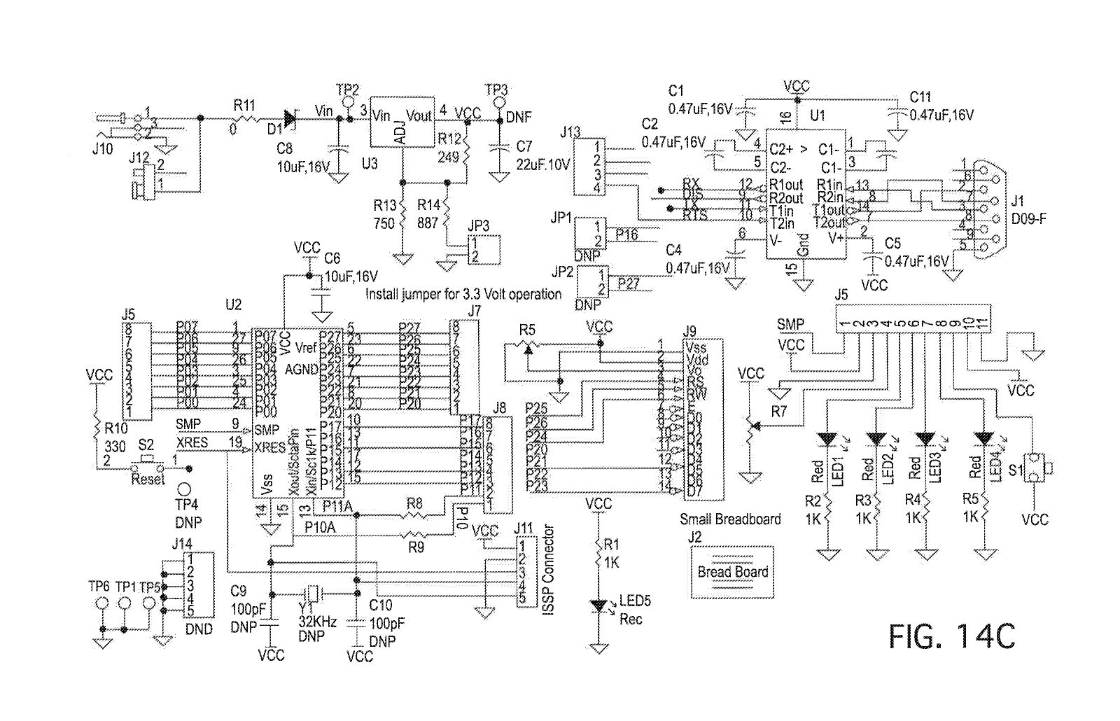

The circuit technology used to drive haptic electronics can be selected to optimize the footprint of the circuit (i.e. reduce the size of the circuit), increase the efficiency of the haptic actuator, and potentially reduce costs. The following Figures identify examples of such circuit diagrams. FIG. 14A illustrates one example comprising a power supply for a photoflash controller. FIG. 14B illustrates a second example circuit comprising a push-pull metal-oxide-semiconductor field-effect transistor (MOSFET) array with closed loop feedback. In addition, FIG. 14C illustrates one example of schematics for a circuit design to drive the haptic assembly coupled to an electronic media device.

As for other details of the present invention, materials and alternate related configurations may be employed as within the level of those with skill in the relevant art. The same may hold true with respect to method-based aspects of the invention in terms of additional acts as commonly or logically employed. In addition, though the invention has been described in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Any number of the individual parts or subassemblies shown may be integrated in their design. Such changes or others may be undertaken or guided by the principles of design for assembly.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “an,” “said,” and “the” include plural referents unless the specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth in the claims. Stated otherwise, unless specifically defined herein, all technical and scientific terms used herein are to be given as broad a commonly understood meaning as possible while maintaining claim validity.

What is claimed is:

1. A housing assembly for removably coupling with an electronic media device that is configured to deliver an output signal to an output port, where the housing assembly produces a haptic effect in response to the output signal of the electronic media device, the housing assembly comprising:
a housing case adapted to nest at least a portion of the electronic media device, the housing including at least one media device connector adapted to detachably couple to the output port of the electronic media device;
at least one electroactive polymer actuator having an active portion configured to produce movement in response to a triggering signal;
a body mass located within the housing case and coupled to the electroactive polymer actuator, where the haptic effect of the electroactive polymer actuator comprises an inertial movement of the body mass; and
at least one drive electronics assembly configured to electronically couple the electroactive polymer actuator to the media device connector, such that the drive electronics assembly is capable of generating the triggering signal in response to the output signal of the electronic media device.

2. The assembly according to claim 1, wherein the electroactive polymer comprises at least one electroactive polymer cartridge, where the electroactive polymer cartridge includes an electroactive polymer film comprising a dielectric elastomer layer, wherein a portion of the dielectric elastomer layer is between a first and a second electrodes wherein the overlapping portions of the electrodes define an active area comprising the active portion, whereupon application of a triggering signal to the electrodes causes movement of the active area to produce the haptic effect.

3. The assembly according to claim 2, where the electroactive polymer actuator comprises a plurality of discrete electroactive polymer cartridges coupled together, where the electroactive polymer actuator includes an increased active portion comprising each active area of each electroactive polymer cartridge.

4. The assembly according to claim 1, further comprising a pocket located within an interior of the housing case, where the body mass is located within the pocket.

5. The assembly according to claim 4, where the pocket is sized to limit movement of the body mass to limit movement of the electroactive polymer actuator.

6. The assembly according to Claim I, a power supply located within the housing case, where the power supply comprises the body mass.

7. The assembly according to claim 6, where the power supply is coupled to the electroactive polymer actuator such that movement of the active area causes inertial movement of the power supply to produce the haptic effect.

8. The assembly according to claim 1, where the electroactive actuator is coupled to the media device, such that the haptic effect is discernable on the media device.

9. The assembly according to claim 1, where the housing case comprises a body shape being symmetrical about the electronic media device when coupled thereto.

10. The assembly according to claim 1, where the housing case further comprises at least one audio speaker, and where the electronic drive assembly is configured to pass the output signal of the electronic media device through to the audio speaker.

11. The assembly according to claim 1, where the housing case comprises a plurality of components capable of being removably coupled together to nest the electronic media assembly.

12. A method of augmenting a stand alone electronic media device to produce an improved haptic effect, the method comprising:
providing a housing including at least one media device connector adapted to couple to an output port of the electronic media device, the housing further includes at least one electroactive polymer actuator having an active portion;
coupling the output port of the electronic media device to device connector;
producing a triggering signal in response to an output signal of the electronic media device; and
generating the improved haptic effect by transmitting the triggering signal to the electroactive polymer actuator to cause movement of the active portion.

13. The method according to claim 12, where generating the improved haptic effect by transmitting the triggering signal to the electroactive polymer actuator to cause movement of the active portion causes inertial movement of a body mass within the housing case.

14. The method according to claim 13, where the body mass comprises a power supply electrically coupled to the electroactive polymer actuator.

15. The method according to claim 13, further comprising a power supply located within the housing, where the at least one electroactive polymer actuator is powered by the power supply and separate from the electronic media device.

16. The method according to claim 12, where producing the triggering signal in response to the output signal of the electronic media device further comprises transmitting the output signal to at least one external speaker coupled to the housing case.

17. The method according to claim 12, where producing the triggering signal in response to the output signal of the electronic media device comprises assessing the output signal and selecting an output mode of the electroactive actuator from a plurality of output modes depending on the output signal.

18. The method according to claim 12, where the output signal comprises an audio signal.

19. A method of producing a housing assembly to augment a haptic effect of a stand alone electronic media device when coupled thereto, the method comprising:
positioning at least one electroactive polymer actuator having an active portion within a housing structure including at least one media device connector that allows for detachable joining of the electronic media device to the housing structure;
coupling an inertial mass to the active portion, such that movement of the active portion creates the haptic effect by inertial movement of the inertial mass, where the haptic effect is felt in the housing assembly or electronic media device when coupled thereto; and
providing within the housing electronic drive circuitry to electrically couple the media device connector to the electroactive polymer actuator and to generate a trigger signal upon receipt of an output signal from the electronic media device, where the electronic drive circuitry is configured to transmit the trigger signal to the electroactive polymer actuator to cause movement of the active portion.

20. The method according to claim 19, further comprising increasing a total surface area of the active portion by coupling a plurality of electroactive polymer cartridges, each having an electroactive polymer film comprising a dielectric elastomer layer, wherein a portion of the dielectric elastomer layer is between a first and a second electrodes wherein the overlapping portions of the electrodes define an active area; where the active portion comprises a total area of the plurality of active areas.

21. The method according to claim 19, further comprising configuring the electronic drive circuitry to assess the output signal and select an output mode of the electroactive actuator from a plurality of output modes depending on the output signal.

22. The method according to claim 19, where coupling the inertial mass to the active portion comprises coupling a power supply to the active portion.

23. The method according to claim 22, further comprising electrically isolating the power supply from the electronic media device so the power supply supplies energy to the drive circuitry and electroactive polymer actuator.

24. The method according to claim 19, where coupling an inertial mass to the active portion comprises coupling the inertial mass to an output member of the active portion.

25. A housing assembly for removably coupling with an electronic media device that is configured to deliver an output signal to an output port, where the housing assembly produces a haptic effect in response to the output signal of the electronic media device, the housing assembly comprising:
a housing case adapted to nest at least a portion of the electronic media device, the housing including at least one media device connector adapted to detachably couple to the output port of the electronic media device;
at least one actuator having an active portion configured to produce movement in response to a triggering signal;
a body mass located within the housing case and coupled to the actuator, where the haptic effect of the actuator comprises an inertial movement of the body mass;
at least one drive electronics assembly configured to electronically couple the actuator to the media device connector, such that the drive electronics assembly is capable of generating the triggering signal in response to the output signal of the electronic media device.

26. A method of augmenting a stand alone electronic media device to produce an improved haptic effect, the method comprising:
providing a housing including at least one media device connector adapted to couple to an output port of the electronic media device, the housing further includes at least one electroactive polymer actuator having an active portion;
coupling the output port of the electronic media device to device connector;
producing a triggering signal in response to an output signal of the electronic media device; and
generating the improved haptic effect by transmitting the triggering signal to the actuator to cause movement of the active portion.

27. A housing assembly for removably coupling with an electronic media device that is configured to deliver an output signal to an output port, where the housing assembly produces a haptic effect in response to the output signal of the electronic media device, the housing assembly comprising:
a housing case adapted to nest at least a portion of the electronic media device, the housing including at least one media device connector adapted to detachably couple to the output port of the electronic media device;
at least one actuator having an active portion configured to produce movement in response to a triggering signal, where movement of the active portion creates the haptic effect discernable on or at the housing assembly;
a power supply located within the housing case, where the power supply is electrically coupled to the actuator; and
at least one drive electronics assembly configured to electronically couple the actuator to the media device connector, such that the drive electronics assembly is capable of generating the triggering signal in response to the output signal of the electronic media device.

28. A housing assembly for removably coupling with an electronic media device that is configured to deliver an output signal to an output port, where the housing assembly produces a haptic effect in response to the output signal of the electronic media device, the housing assembly comprising:
a housing case adapted to nest at least a portion of the electronic media device, the housing including at least one media device connector adapted to detachably couple to the output port of the electronic media device;
at least one actuator having an active portion configured to produce movement in response to a triggering signal, where movement of the active portion creates the haptic effect discernable on or at the surface of the electronic media device;
at least one drive electronics assembly configured to electronically couple the actuator to the media device connector, such that the drive electronics assembly is capable of generating the triggering signal in response to the output signal of the electronic media device.
